(19) United States
(12) Patent Application Publication
(10) Pub. No.: US 2010/0267252 A1
(43) Pub. Date: Oct. 21, 2010

(54) ELECTRONIC COMPONENT AND ELECTRONIC CONTROL DEVICE USING THE SAME

(75) Inventor: Katsuya Fujimoto, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/066,520

(22) PCT Filed: Sep. 28, 2007
(86) PCT No.: PCT/JP2007/068957

§ 371 Date: Mar. 12, 2008

(30) Foreign Application Priority Data
Sep. 29, 2006 (JP) 2006-267630
Oct. 13, 2006 (JP) 2006-280051
Nov. 13, 2006 (JP) 2006-306343

(51) Int. Cl. H01R 13/05; H01R 12/00

(52) U.S. Cl. 439/55; 439/825; 361/518

(57) ABSTRACT

An electronic component includes an electronic component body having lead wires led out therefrom and compliant pins. Compliant pins include connections to be connected to lead wires and are in contact, at end surfaces on the other side thereof, with a lead-wire lead-out surface of the electronic component body. Compliant pins are provided at one end thereof with connectors to be press-fitted into the throughholes of a circuit board.

### TECHNICAL FIELD

The present invention relates to electronic components capable of being mounted on a circuit board by press-fitting compliant pins into the circuit board, and to an electronic control device using such an electronic component.

### BACKGROUND ART

To rationalize the production of electronic devices, the mounting of electronic components on a circuit board has been increasingly performed by reflow soldering. Furthermore, more lead-free solder materials have been used in recent years to reduce environmental load substances.

Lead-free solder materials, however, have higher melting points than the conventional leaded-solder materials, thus causing the reflow heat to be absorbed by an electronic component body, especially when the component has a large volume. This restrains a temperature rise of lead wires, making it difficult to solder the lead wires to the circuit board. To overcome this problem, it has been suggested to provide electronic components with compliant pins, which do not require a soldering process. The compliant pins are press-fitted into the plated throughholes of the circuit board to achieve electrical connection.

Conventionally, this type of electronic component is called P-PGA (plastic pin grid array) and has a structure shown in FIG. 75 as a side view and FIG. 76 as a bottom view.

In FIGS. 75 and 76, electronic component 10 includes electronic component body 1 and lead wires 2. Electronic component body 1 includes various semiconductor integrated circuits (ICs) mounted on a plastic substrate and is entirely sealed with a plastic material (for example, epoxy resin). Lead wires 2, as shown in FIG. 75, are led out from the bottom of electronic component body 1 and themselves form compliant pins 3 at their ends. Compliant pins 3 are press-fitted into the throughholes of a circuit board so that lead wires 2 can be connected to the circuit board. The press-fitting of lead wires 2 into the throughholes allows electronic component 10 to be mounted on a circuit board without soldering.

One of the prior arts related to the present invention is Patent Document 1 shown below.

In electronic component 10 with the above-described conventional compliant pins, lead wires 2 led out from electronic component body 1 themselves function as compliant pins 3 by having an end shape suitable to be pressed into the throughholes of a circuit board. The problem is that this causes lead wires 2 of the electronic component to directly receive the load applied to the ends of compliant pins 3 when they are pressed into the throughholes of the circuit board.

FIGS. 77 and 78 show a perspective view and a sectional view, respectively, of electrolytic capacitor 11 of the general conventional type. Electrolytic capacitor 11 includes capacitor element 13, sealing member 14 made of an elastic material, and cylindrical outer metal case 15. Capacitor element 13 includes a pair of lead wires 12 and is impregnated with an electrolytic solution for driving. The pair of lead wires 12 led out from capacitor element 13 penetrate sealing member 14, and capacitor element 13 is stored in outer metal case 15. Outer metal case 15 is sealed by crimping and curling its opening at crimped portion 16 and at curled portion 17, respectively, together with sealing member 14. Lead wires 12 are led out from the body of electrolytic capacitor 11 through sealing member 14. If compliant pins are applied to lead wires 12 of electrolytic capacitor 11, the following problems occur. Sealing member 14 made of an elastic material such as rubber holds lead wires 12 at a strength lower than the press-fit load applied during the mounting to the circuit board. Moreover, the press-fit load is transmitted to capacitor element 13 via lead wires 12, thus short-circuiting capacitor element 13 or deteriorating the hermeticity of sealing member 14.

An electrolytic capacitor, on the other hand, is required to have a large capacity when used as a power backup capacitor in an electronic control device for an automobile, for example, in an electronic control device for air-bags and pretensioner seatbelts. This causes the body of electrolytic capacitor 11 to be large in size and weight. Therefore, when compliant pins are applied to lead wires 12 of electrolytic capacitor 11 and simply press-fitted into the circuit board, the durability of electrolytic capacitor 11 is not ensured. More specifically, when subjected to mechanical stress such as vibration or impact in the environment in which the automobile is used, the body of electrolytic capacitor 11 is too heavy to fully prevent its vibration. This may cause breakage of lead wires 12 or other related problems.

Patent Document 1: Japanese patent No. 3418030

### SUMMARY OF THE INVENTION

To solve the above-described conventional problem, the present invention has an object of providing an electronic component with stable reliability by press-fitting compliant pins into the throughholes of a circuit board, thereby reducing the load applied to the lead wires of the electronic component body.

In order to achieve the above object, the electronic component of the present invention includes an electronic component body having lead wires led out therefrom; and compliant pins having, at one end thereof, connectors to be press-fitted into the throughholes of a circuit board, the compliant pins also having connections to be connected to the lead wires.

The compliant pins may be in contact, at end surfaces on the other side thereof, with a lead-wire lead-out surface of the electronic component body.

In this structure, the load applied when the compliant pins connected to the lead wires are press-fitted into the throughholes of the circuit board is absorbed to where the end surfaces of the compliant pins are in contact with the lead-wire lead-out surface. This prevents the load from being transmitted to an inner element via the lead wires of the electrolytic capacitor body, thereby stably ensuring reliability of the electronic component.

The electronic component may further include an insulating terminal plate in contact with part of the lead-wire lead-out surface of the electronic component body, and the compliant pins may be partially fixed to the terminal plate and provided at the other end with connections to be connected to the lead wires.

In this structure, the load applied when the compliant pins connected to the lead wires are press-fitted into the throughholes of the circuit board is absorbed to where the terminal plate is in contact with the lead-wire lead-out surface of the electronic component body. This prevents the load from being transmitted to an inner element via the lead wires of the electrolytic capacitor body, thereby stably ensuring reliability of the electronic component.

The electronic component may further include a holder for fixedly holding the electronic component body, and the compliant pins may be partially fixed to the holder and provided on the other end with connections to be connected to the lead wires.

In this structure, the load applied when the compliant pins connected to the lead wires are press-fitted into the throughholes of the circuit board is absorbed by a holder partially fixing the compliant pins. This prevents the load applied during the press-fitting from being transmitted to an inner element of the electrolytic capacitor body via the lead wires so as not to short-circuit the inner element or not to deteriorate the hermeticity of the portion where the lead wires are led out from the electronic component body. In addition, the holder can fixedly hold the electronic component body to reduce the vibration of the electronic component body due to mechanical stress such as vibration or impact. This prevents the lead wires from damage such as fracture, thereby stably ensuring reliability of the electronic component.

The electronic control device for an automobile according to the present invention may have a circuit board and electronic components mounted thereon including the above-described electronic component.

This structure allows the electronic component capable of stably having reliability to be mounted on a circuit board, thereby providing a highly reliable electronic control device for an automobile.

### BRIEF DESCRIPTION OF THE DRAWINGS

FIG. 1 is a perspective view of an electronic component according to a first embodiment of the present invention.

FIG. 2 is a sectional view of the electronic component according to the first embodiment of the present invention.

FIG. 3 is a perspective view of another electronic component according to the first embodiment of the present invention.

FIG. 4 is a perspective view of another electronic component according to the first embodiment of the present invention.

FIG. 5 is a perspective view of another electronic component according to the first embodiment of the present invention.

FIG. 6 is a perspective view of another electronic component according to the first embodiment of the present invention.

FIG. 7 is a perspective view of an electronic component according to a second embodiment of the present invention.

FIG. 8 is a bottom view of the electronic component according to the second embodiment of the present invention.

FIG. 9 is a perspective view of another electronic component according to the second embodiment of the present invention.

FIG. 10 is a perspective view of an electronic component according to a third embodiment of the present invention.

FIG. 11 is a perspective view before compliant pins are connected to the electronic component body of the electronic component according to the third embodiment of the present invention.

FIG. 12 is a perspective view of an electronic component according to a fourth embodiment of the present invention.

FIG. 13 is a perspective view of another component according to the fourth embodiment of the present invention.

FIG. 14 is a sectional view of an electronic component according to a fifth embodiment of the present invention.

FIG. 15 is a sectional view of the electronic component according to the fifth embodiment of the present invention.

FIG. 16 is a perspective view of an electronic component according to a sixth embodiment of the present invention.

FIG. 17 is a sectional view of the electronic component according to the sixth embodiment of the present invention.

FIG. 18 is a sectional view (90 degrees away from the direction of FIG. 2) of the electronic component according to the sixth embodiment of the present invention.

FIG. 19 is a bottom view of the electronic component according to the sixth embodiment of the present invention.

FIG. 20 is a perspective view of another electronic component according to the sixth embodiment of the present invention.

FIG. 21 is a sectional view of the electronic component according to the sixth embodiment of the present invention.

FIG. 22 is a perspective view of an electronic component according to a seventh embodiment of the present invention.

FIG. 23 is a sectional view of the electronic component according to the seventh embodiment of the present invention.

FIG. 24 is a perspective view of anther electronic component according to the seventh embodiment of the present invention.

FIG. 25 is a sectional view of the electronic component according to the seventh embodiment of the present invention.

FIG. 26 is a perspective view of another electronic component according to the seventh embodiment of the present invention.

FIG. 27 is a sectional view of the electronic component according to the seventh embodiment of the present invention.

FIG. 28 is a perspective view of an electronic component according to an eighth embodiment of the present invention.

FIG. 29 is a sectional view of the electronic component according to the eighth embodiment of the present invention.

FIG. 30 is a perspective view of another electronic component according to the eighth embodiment of the present invention.

FIG. 31 is a sectional view of the electronic component according to the eighth embodiment of the present invention.

FIG. 32 is a perspective view of an electronic component according to a ninth embodiment of the present invention.

FIG. 33 is a perspective view of another electronic component according to the ninth embodiment of the present invention.

FIG. 34 is a perspective view of an electronic component according to a tenth embodiment of the present invention.

FIG. 35 is a sectional view of the electronic component according to the tenth embodiment of the present invention.

FIG. 36 is a sectional view of an electronic component according to an eleventh embodiment of the present invention.

FIG. 37 is a sectional view of another electronic component according to the eleventh embodiment of the present invention.

FIG. 38 is a perspective view of an electronic component according to a twelfth embodiment of the present invention.

FIG. 39 is a front view of the electronic component according to the twelfth embodiment of the present invention.

FIG. 40 is a rear view of the electronic component according to the twelfth embodiment of the present invention.

FIG. 41 is a side view of the electronic component according to the twelfth embodiment of the present invention.

FIG. 42 is a sectional view of the electronic component according to the twelfth embodiment of the present invention.

FIG. 43 is a top view of the electronic component according to the twelfth embodiment of the present invention.

FIG. 44 is a bottom view of the electronic component according to the twelfth embodiment of the present invention.

FIG. 45 is a perspective view of another electronic component according to the twelfth embodiment of the present invention.

FIG. 46 is a perspective view of another electronic component according to the twelfth embodiment of the present invention.

FIG. 47 is a perspective view of an electronic component according to a thirteenth embodiment of the present invention.

FIG. 48 is a front view of the electronic component according to the thirteenth embodiment of the present invention.

FIG. 49 is a rear view of the electronic component according to the thirteenth embodiment of the present invention.

FIG. 50 is a side view of the electronic component according to the thirteenth embodiment of the present invention.

FIG. 51 is a top view of the electronic component according to the thirteenth embodiment of the present invention.

FIG. 52 is a bottom view of the electronic component according to the thirteenth embodiment of the present invention.

FIG. 53 is a perspective view of an electronic component according to a fourteenth embodiment of the present invention.

FIG. 54 is a side view of the electronic component according to the fourteenth embodiment of the present invention.

FIG. 55 is a bottom view of the electronic component according to the fourteenth embodiment of the present invention.

FIG. 56 is a bottom view of another electronic component according to the fourteenth embodiment of the present invention.

FIG. 57 is a perspective view of the electronic component according to the fourteenth embodiment of the present invention.

FIG. 58 is a perspective view of an electronic component according to a fifteenth embodiment of the present invention.

FIG. 59 is a perspective view of the electronic component according to the fifteenth embodiment of the present invention.

FIG. 60 is a perspective view of another electronic component according to the fifteenth embodiment of the present invention.

FIG. 61 is a perspective view of another electronic component according to the fifteenth embodiment of the present invention.

FIG. 62 is a perspective view of an electronic component according to a sixteenth embodiment of the present invention.

FIG. 63 is a perspective view of the electronic component according to the sixteenth embodiment of the present invention.

FIG. 64 is a front view of the electronic component according to the sixteenth embodiment of the present invention.

FIG. 65 is a front view of the electronic component according to the sixteenth embodiment of the present invention.

FIG. 66 is a rear view of the electronic component according to the sixteenth embodiment of the present invention.

FIG. 67 is a rear view of the electronic component according to the sixteenth embodiment of the present invention.

FIG. 68 is a perspective view of another electronic component according to the sixteenth embodiment of the present invention.

FIG. 69 is a perspective view of another electronic component according to the sixteenth embodiment of the present invention.

FIG. 70 is a perspective view of an electronic component according to a seventeenth embodiment of the present invention.

FIG. 71 is a perspective view of another electronic component according to the seventeenth embodiment of the present invention.

FIG. 72 is a top view of an electronic component according to an eighteenth embodiment of the present invention.

FIG. 73 is a top view of another electronic component according to the eighteenth embodiment of the present invention.

FIG. 74 is a schematic circuit configuration diagram of an electronic control device for an automobile using one of the electronic components according to the first to eighteenth embodiments of the present invention.

FIG. 75 is a side view of an electronic component having conventional compliant pins.

FIG. 76 is a bottom view of the electronic component having the conventional compliant pins.

FIG. 77 is a perspective view of a general conventional electrolytic capacitor.

FIG. 78 is a sectional view of the general conventional electrolytic capacitor de

### REFERENCE MARKS IN THE DRAWINGS

21, 21a, 21b electrolytic capacitor body (electronic component body)

22, 22a, 22b lead wire

23 capacitor element

24 sealing member

25 outer metal case

26 crimped portion

27 curled portion

28 connection

29 end

30 lead-wire lead-out surface

31 throughhole

32, 32a, 32b, 32c connector

33 base

34, 74, 81 compliant pin

35, 35a, 35b, 88 recess

36 rib

37 depression in the lead-wire lead-out surface

42a anode-side connector

42b cathode-side connector

43a anode-side base

43b cathode-side base

52a, 62a anode lead wire

52b, 62b cathode lead wire

55a, 65a, 85a anode-side recess

55b, 65b, 85b cathode-side recess

71 terminal plate

72 notch

73 contact

75 groove

76 through-hole

77, 77a, 77b wall

78, 86 projection

79 chamfered portion

80, 80b, 80c holder

80a, 80d holding member

81a auxiliary compliant pin

82 circuit board

83a, 83b planar portion

84 groove

85 stepped portion

87 projection

90 electronic control device

91 acceleration sensor

92 air-bag

93 pretensioner seatbelt

94 control microcomputer

95 driving circuit

96 power monitor fail-safe IC

97 battery

98 DC/DC converter

99 power backup capacitor

100 backup circuit

### DETAILED DESCRIPTION OF PREFERRED EMBODIMENTS

Electronic components and an electronic control device for an automobile according to the embodiments of the present invention are described as follows with reference to drawings. In the drawings, the electronic components and the electronic control device are shown in an enlarged scale for easier understanding. Like components are labeled with like reference numerals, and the description of these components is sometimes not repeated.

### First Embodiment

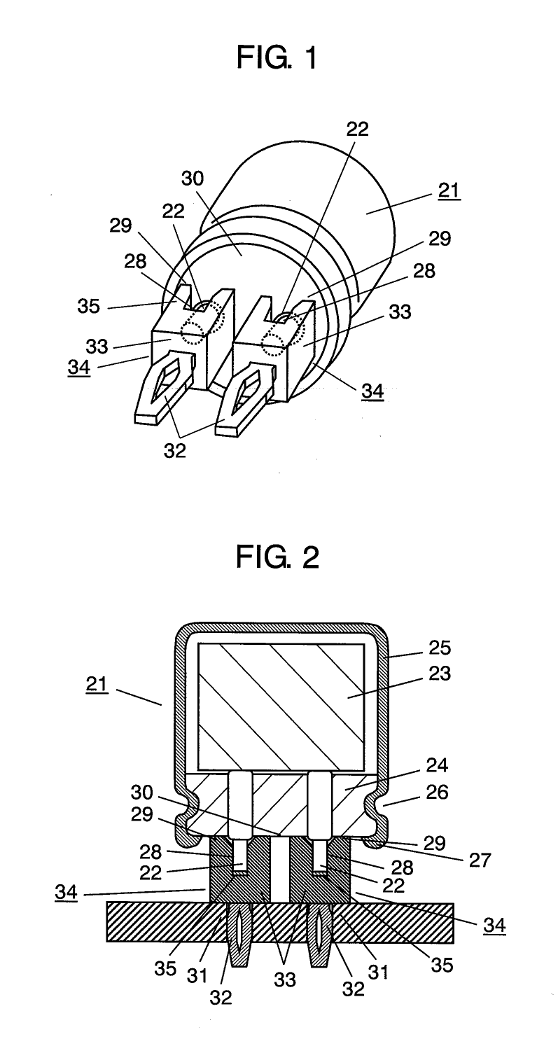

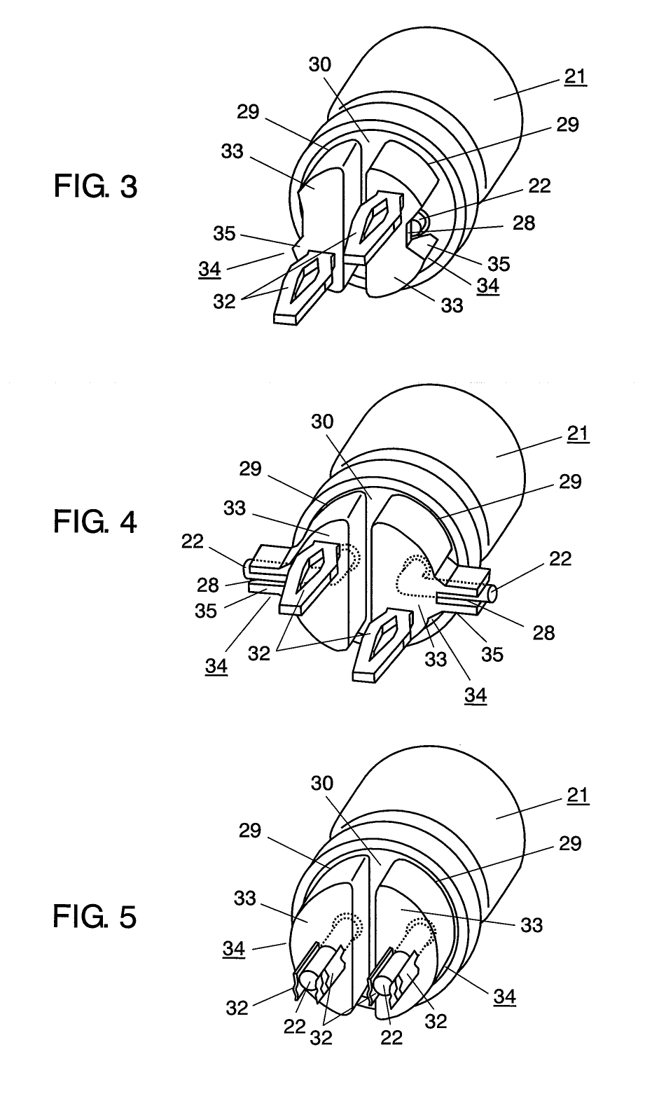

FIG. 1 is a perspective view of an electronic component according to a first embodiment of the present invention, and FIG. 2 is a sectional view of the electronic component. FIGS. 3 to 6 are perspective views of other electronic components according to the first embodiment.

In FIGS. 1 and 2, electrolytic capacitor body 21 is taken as an example of electronic component body 21 of an electronic component. The electronic component (electrolytic capacitor) includes capacitor element 23, sealing member 24 made of an elastic material such as rubber, and outer metal case 25 made of a metallic material such as aluminum. Capacitor element 23 has a pair of lead wires 22 and is impregnated with an electrolytic solution for driving (unillustrated). The pair of lead wires 22 led out from capacitor element 23 penetrate sealing member 24. The electrolytic capacitor includes electrolytic capacitor body 21 and compliant pins 34.

The structure of electrolytic capacitor body 21 is general in that capacitor element 23 is stored in outer metal case 25 and that outer metal case 25 is sealed by crimping and curling its opening at crimped portion 26 and at curled portion 27, respectively, together with sealing member 24. Compliant pins 34 are provided at one end thereof with connectors 32 to be press-fitted into throughholes 31 of a circuit board. Compliant pins 34 also include connections 28 to be connected to lead wires 22 made of a metallic material. Compliant pins 34 are in contact, at end surfaces 29 on the other side thereof, with sealing member 24 which is made of an elastic material such as rubber and forms lead-wire lead-out surface 30 of electrolytic capacitor body 21.

The area where end surfaces 29 on the other side of compliant pins 34 are in contact with lead-wire lead-out surface 30 of electrolytic capacitor body 21 is set to a size large enough to absorb the load applied when compliant pins 34 are pressed into throughholes 31 of the circuit board.

Compliant pins 34 include recesses 35 for engaging lead wires 22 as connections 28. Recesses 35 allow lead wires 22 to be fitted thereinto and to be connected to compliant pins 34 by welding, soldering, pressure welding, or the like.

In the above-described structure, end surfaces 29 on the other side of compliant pins 34 connected to lead wires 22 are in contact with lead-wire lead-out surface 30. And the load applied when connectors 32 at one end of compliant pins 34 are press-fitted into throughholes 31 of the circuit board is absorbed to where end surfaces 29 of compliant pins 34 are in contact with lead-wire lead-out surface 30. The electrolytic capacitor of the present first embodiment thus prevents the load from being transmitted to capacitor element 23 via lead wires 22 of electrolytic capacitor body 21 so as to be resistant to short-circuit and highly hermetic, thus having stable reliability.

In addition, recesses 35 of compliant pins 34 accommodate lead wires 22 led out from electrolytic capacitor body 21 to facilitate the connection and hence the workability. Compliant pins 34 have bases 33 having a nearly rectangular parallelepiped shape.

Compliant pins 34 may alternatively have semi-cylindrical bases 33 and recesses 35 for engaging lead wires 22 as connections 28 as shown in FIG. 3, or semi-cylindrical bases 33 and recesses 35 for engaging lead wires 22 bent orthogonally as connections 28 as shown in FIG. 4. These structures can increase the area where end surfaces 29 of compliant pins 34 are in contact with lead-wire lead-out surface 30. This then results in an increase in the margin to absorb the load applied when compliant pins 34 are press-fitted into throughholes 31 of a circuit board, thereby providing the electrolytic capacitor with more stable reliability.

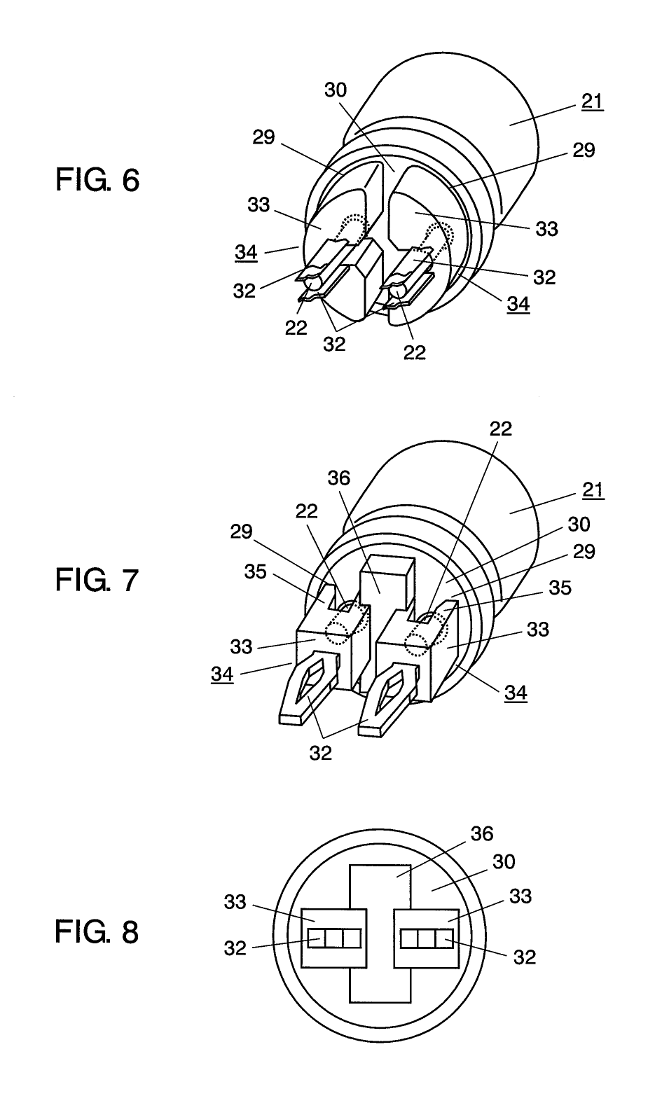

Compliant pins 34 may have connectors 32 in the form of split pins. More specifically, split-pin-shaped connectors 32 hold lead wires 22 by allowing them to penetrate their centers as shown in FIG. 5 or hold lead wires 22 in their centers in parallel with the split pins as shown in FIG. 6. In these structures, lead wires 22, compliant pins 34, and the plated inner walls of throughholes 31 can be pressure-welded to each other to ensure the electrical connection when compliant pins 34 holding lead wires 22 therein are press-fitted into throughholes 31 of the circuit board. This allows compliant pins 34 and lead wires 22 to be connected to each other without the trouble of welding, soldering, or the like, thus facilitating the workability.

### Second Embodiment

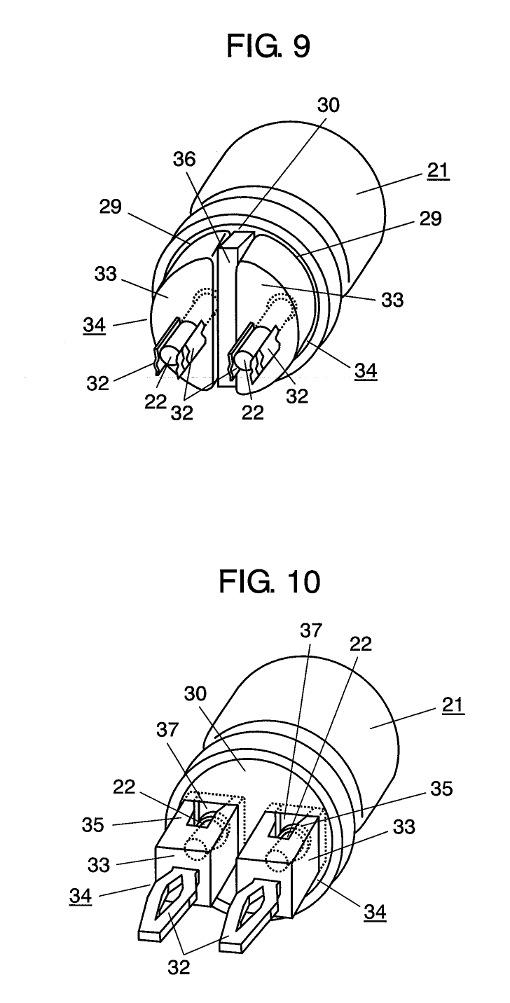

FIG. 7 is a perspective view of an electronic component according to a second embodiment of the present invention, FIG. 8 is a bottom view of the electronic component, and FIG. 9 is a perspective view of another electronic component according to the second embodiment. Like components are labeled with like reference numerals with respect to the first embodiment, and the description of these components is omitted. As shown in FIGS. 7 and 8, the present embodiment differs from the first embodiment in that in electrolytic capacitor body 21, sealing member 24 made of an elastic material such as rubber has I-shaped rib 36 integrated therewith on the side of lead-wire lead-out surface 30. Rib 36 is closely arranged between compliant pins 34 having square-column-shaped bases 33.

This structure facilitates and ensures the positioning of compliant pins 34. In addition, this structure increases the area where end surfaces 29 of compliant pins 34 are in contact with lead-wire lead-out surface 30, prevents the contact between compliant pins 34, and reduces the load applied to lead wires 22.

Alternatively, as shown in FIG. 9, when compliant pins 34 have semi-cylindrical bases 33 with planar side portions facing each other to increase the area where end surfaces 29 are in contact with lead-wire lead-out surface 30, rib 36 can have a rectangular parallelepiped shape arranged between the planar side portions. This structure increases the area where end surfaces 29 of compliant pins 34 are in contact with lead-wire lead-out surface 30. As a result, the electrolytic capacitor (electronic component) has a larger margin to absorb the press-fit load of compliant pins 34, thus having more stable reliability.

Rib 36 maybe made of an insulator of a resin material and be arranged between compliant pins 34 by being bonded to or being led out from lead-wire lead-out surface 30. Thus, rib 36 maybe others as long as it can isolate compliant pins 34 from each other to obtain the same effect.

### Third Embodiment

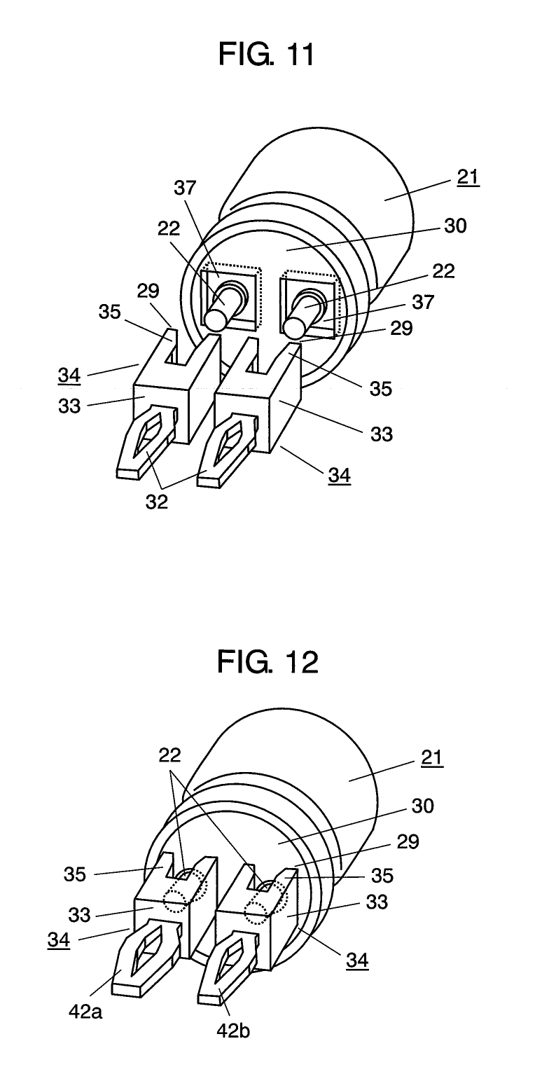

FIG. 10 is a perspective view of an electronic component according to a third embodiment of the present invention, and FIG. 11 is a perspective view before the compliant pins are connected to the electronic component body of the electronic component. Like components are labeled with like reference numerals with respect to the first embodiment, and the description of these components is omitted.

As shown in FIGS. 10 and 11, the present embodiment differs from the first embodiment shown in FIG. 1 in that in electrolytic capacitor body 21, sealing member 24 made of an elastic material such as rubber has depressions 37 molded on the side of lead-wire lead-out surface 30. Depressions 37 are provided to accommodate end surfaces 29 of compliant pins 34.

This structure facilitates and ensures the positioning of compliant pins 34, and increases the area where end surfaces 29 of compliant pins 34 are in contact with lead-wire lead-out surface 30. In addition, this structure prevents the contact between compliant pins 34 and reduces the load applied to lead wires 22.

Depressions 37 can have a large area where end surfaces 29 of compliant pins 34 are in contact with lead-wire lead-out surface 30 by making compliant pins 34 semi-cylindrical. This increases the margin to absorb the press-fit load of compliant pins 34, thus having more stable reliability.

### Fourth Embodiment

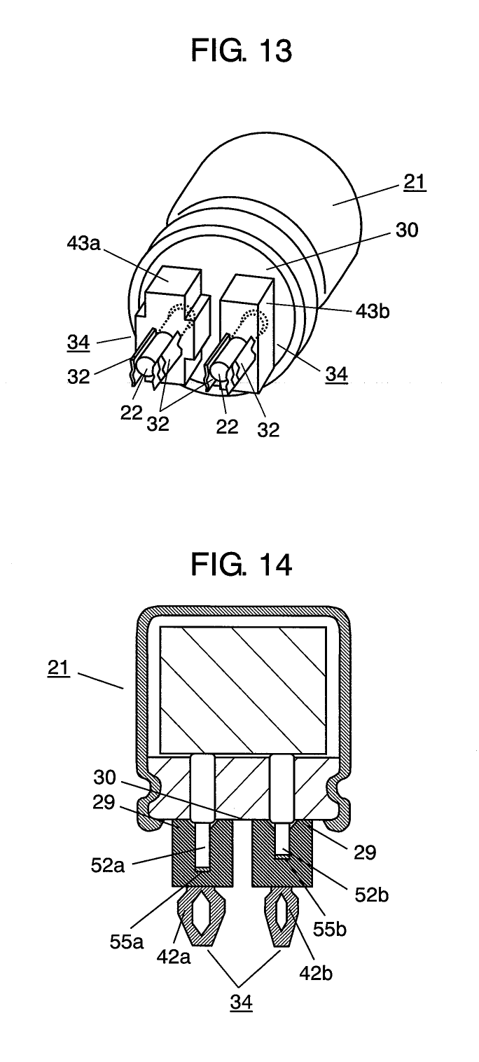

FIG. 12 is a perspective view of an electronic component according to a fourth embodiment of the present invention, and FIG. 13 is a perspective view of another component according to the fourth embodiment. Like components are labeled with like reference numerals with respect to the first embodiment, and the description of these components is omitted.

As shown in FIG. 12, the present embodiment differs from the first embodiment in that compliant pins 34 have a polarity and are respectively provided with anode-side connector 42a and cathode-side connector 42b which are different from each other in size.

This structure facilitates the visual discrimination of the polarities of the electrolytic capacitor, thereby preventing errors in determining the polarities of the components during the assembly of the electronic device.

As shown in FIG. 13, compliant pins 34 may be formed of split-pin-shaped connectors 32 which hold lead wires 22 by allowing them to penetrate their centers, plus-shaped anode-side base 43a, and minus-shaped cathode-side base 43b. Thus, the bases may be different from each other in shape or in color depending on their polarities to obtain the same effect as in FIG. 12.

### Fifth Embodiment

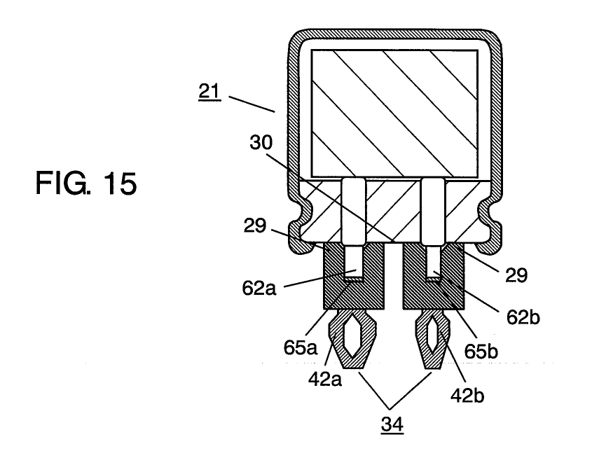

FIG. 14 is a sectional view of an electronic component according to a fifth embodiment of the present invention, and FIG. 15 is a sectional view of another electronic component according to the fifth embodiment. Like components are labeled with like reference numerals with respect to the fourth embodiment, and the description of these components is omitted.

As shown in FIG. 14, the present embodiment differs from the fourth embodiment in the following points. Electrolytic capacitor body 21 leads out anode lead wire 52a and cathode lead wire 52b having different lengths from each other. Compliant pins 34 include anode-side recess 55a and cathode-side recess 55b fitting anode lead wire 52a and cathode lead wire 52b, respectively.

In this structure, a connection cannot be established between compliant pins 34 and the lead wires if they are connected with the wrong polarities. This facilitates visual inspection to detect a wrong polarity connection, thereby preventing errors in determining the polarities during the assembly of the electronic components.

As shown in FIG. 15, electrolytic capacitor body 21 leads out anode lead wire 62a and cathode lead wire 62b having different thicknesses from each other. Accordingly, compliant pins 34 include anode-side recess 65a and cathode-side recess 65b fitting anode lead wire 62a and cathode lead wire 62b, respectively. This facilitates visual inspection to detect a wrong polarity connection, thereby preventing errors in determining the polarities during the assembly of the electronic components.

### Sixth Embodiment

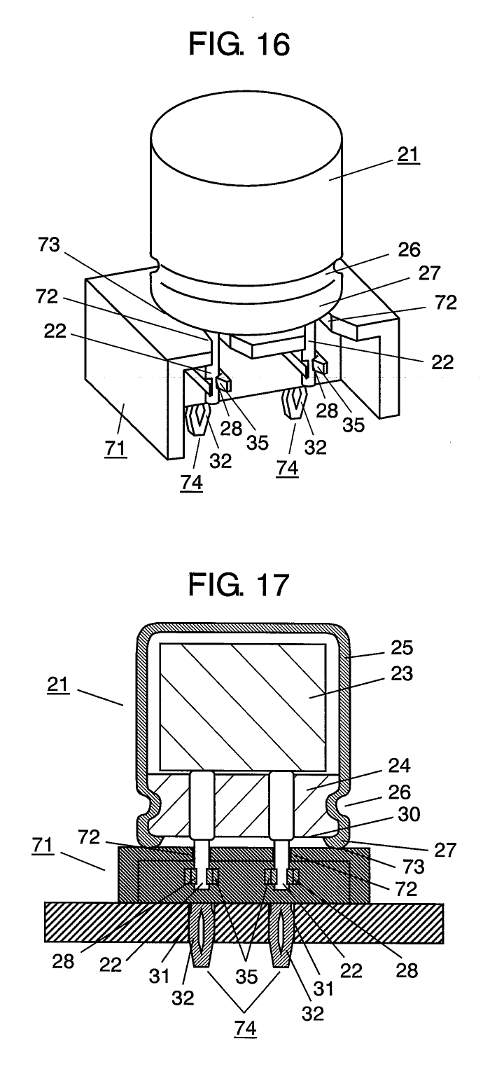

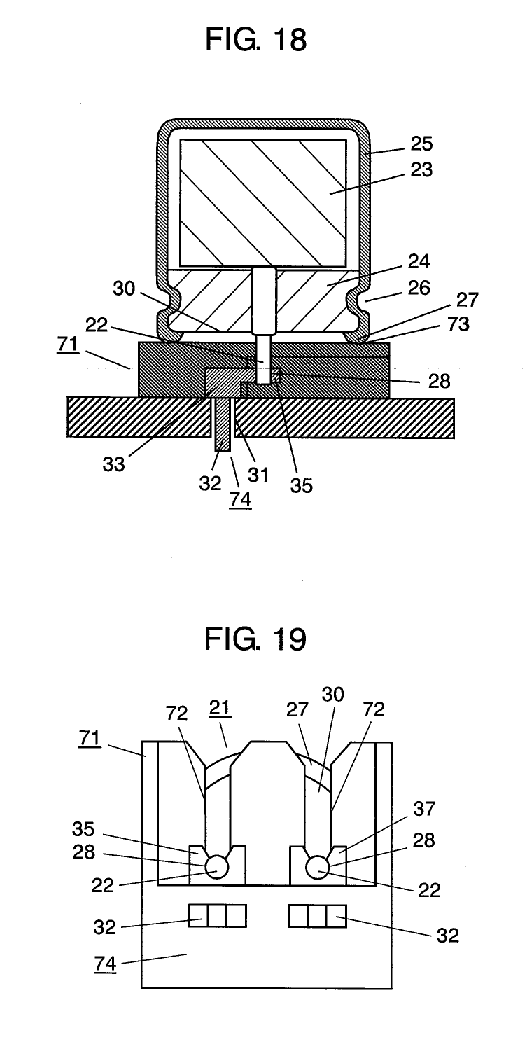

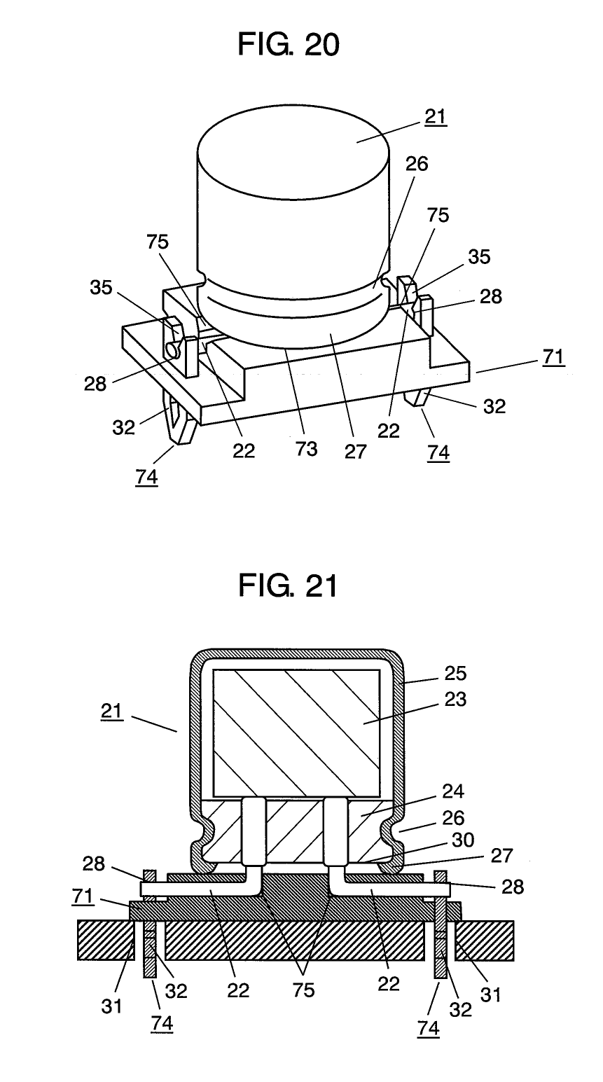

FIG. 16 is a perspective view of an electronic component according to a sixth embodiment of the present invention, FIG. 17 is a sectional view of the electronic component, FIG. 18 is a sectional view (90 degrees away from the direction of FIG. 17) of the electronic component, and FIG. 19 is a bottom view of the electronic component. FIG. 20 is a perspective view of another electronic component according to the sixth embodiment, and FIG. 21 is a sectional view of the electronic component.

In FIGS. 16 to 19, the electronic component includes electronic component body 21 as a general electrolytic capacitor body 21, terminal plate 71 made of an insulating material such as a resin, and compliant pins 74.

Electrolytic capacitor body 21 includes capacitor element 23, sealing member 24 made of an elastic material such as rubber, and outer metal case 25 made of a metallic material such as aluminum. Capacitor element 23 has a pair of lead wires 22 and is impregnated with an electrolytic solution for driving (unillustrated). The pair of lead wires 22 led out from capacitor element 23 penetrate sealing member 24, and capacitor element 23 is stored in outer metal case 25. Outer metal case 25 is sealed by crimping and curling its opening at crimped portion 26 and at curled portion 27, respectively, together with sealing member 24. Sealing member 24 made of an elastic body and curled portion 27 of outer metal case 25 together form lead-wire lead-out surface 30.

Terminal plate 71 has notches 72 on a surface thereof facing lead-wire lead-out surface 30 of electronic component body 21. Notches 72 allow lead wires 22 to pass therethrough. Terminal plate 71 is in contact, at contact 73, with curled portion 27 which is a part of surface 30.

Compliant pins 74 are fixed to terminal plate 71 at bases 33 by, for example, insert molding. Compliant pins 74 are provided at the other end thereof with connections 28 to be connected to lead wires 22 placed in notches 72 of terminal plate 71, and are provided at one end thereof with connectors 32 to be press-fitted into throughholes 31 of the circuit board.

The area where contact 73 of terminal plate 71 is in contact with curled portion 27 as a part of lead-wire lead-out surface 30 is set to a size large enough to absorb the load applied when compliant pins 74 are pressed into throughholes 31 of the circuit board.

In the above-described structure, the load applied when compliant pins 74 are press-fitted into throughholes 31 of the circuit board is absorbed by curled portion 27 of high-strength outer metal case 25 that is made of a metallic material and is apart of surface 30 and by contact 73 in contact with terminal plate 71. This prevents the load applied during the press-fitting from being transmitted to capacitor element 23 via lead wires 22 of electrolytic capacitor body 21. As a result, capacitor element 23 is free from short circuit and sealing member 24 maintains hermeticity, thus ensuring stable reliability of the electrolytic capacitor.

Compliant pins 74 include recesses 35 for engaging lead wires 22 as connections 28. Recesses 35 allow lead wires 22 to be fitted thereinto and to be connected to compliant pins 74 by welding, soldering, pressure welding, or the like.

In this structure, recesses 35 of compliant pins 74 accommodate lead wires 22 led out from electrolytic capacitor body 21 to facilitate the connection and hence the workability.

As shown in FIGS. 20 and 21, the pair of lead wires 22 led out from electrolytic capacitor body 21 may be bent orthogonally in different directions. Terminal plate 71 may have grooves 75 in a surface thereof facing lead-wire lead-out surface 30 in order to accommodate the orthogonally bent lead wires 22.

This structure allows lead wires 22 and connections 28 of compliant pins 74 to be arranged on both sides of electrolytic capacitor body 21, thereby facilitating the connection between lead wires 22 and compliant pins 74.

### Seventh Embodiment

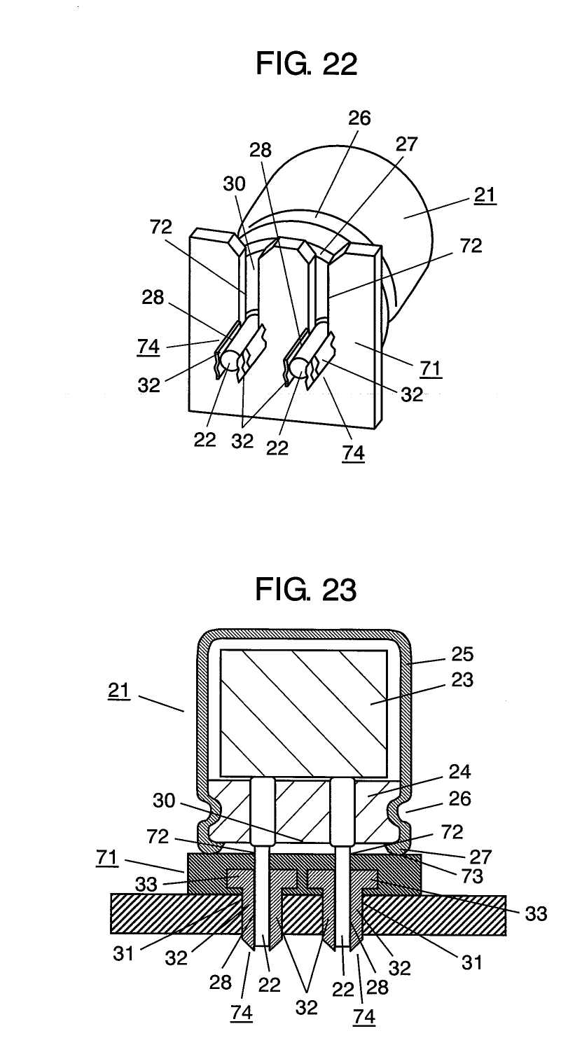

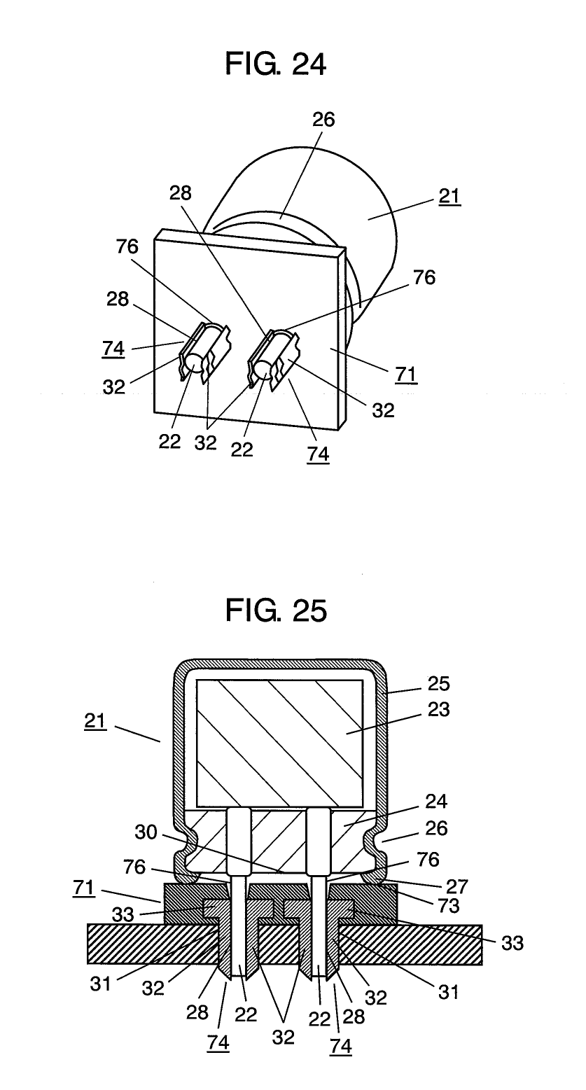

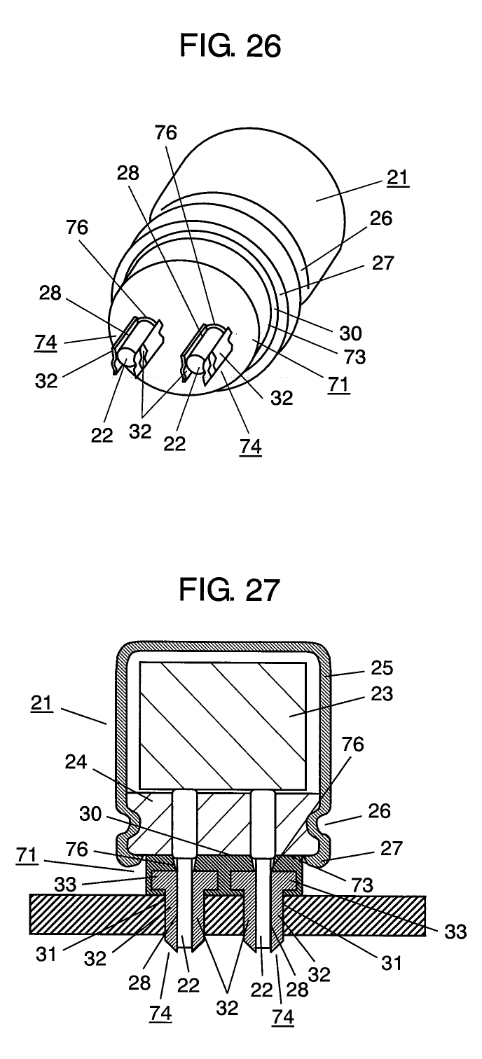

FIG. 22 is a perspective view of an electronic component according to a seventh embodiment of the present invention, and FIG. 23 is a sectional view of the electronic component. FIGS. 24 and 26 are perspective views of other electronic components according to the seventh embodiment. FIGS. 25 and 27 are sectional views of the other electronic components. Like components are labeled with like reference numerals with respect to the sixth embodiment, and the description of these components is omitted.

As shown in FIGS. 22 and 23, the present embodiment differs from the sixth embodiment in that connectors 32 of compliant pins 74 are in the form of split pins. More specifically, split-pin-shaped connectors 32 have central spaces which function as connections 28 to hold lead wires 22 laterally.

In this structure, lead wires 22, compliant pins 74, and the plated inner walls of throughholes 31 can be pressure-welded to each other to ensure the electrical connection when compliant pins 74 connected to lead wires 22 are press-fitted into throughholes 31 of the circuit board. This allows compliant pins 74 and lead wires 22 to be connected to each other without the trouble of welding, soldering, or the like, thus facilitating the workability.

FIGS. 24 and 25 show the case where terminal plate 71 includes through-holes 76 instead of notches 72 in order to allow lead wires 22 to pass therethrough. In this case, compliant pins 74 may have partially fixed base 33, and split-pin-shaped connectors 32 may have central spaces which function as connections 28 to hold lead wires 22 by allowing them to pass therethrough.

Terminal plate 71 not having notches can hold lead wires 22 at a higher strength. Consequently, the load applied when compliant pins 74 connected to lead wires 22 are press-fitted into throughholes 31 of the circuit board can be stably absorbed by curled portion 27 and contact 73. This prevents the load from being transmitted to capacitor element 23 via lead wires 22 of electrolytic capacitor body 21. As a result, capacitor element 23 is free from short circuit and sealing member 24 maintains hermeticity, thus ensuring stable reliability of the electrolytic capacitor.

As shown in FIGS. 26 and 27, terminal plate 71 may be shaped so that contact 73 of terminal plate 71 is entirely in contact with sealing member 24. This structure increases the area where terminal plate 71 is in contact with lead-wire lead-out surface 30 of electrolytic capacitor body 21. As a result, there is an effective reduction in the load applied to lead wires 22 when compliant pins 74 are press-fitted into throughholes 31 of the circuit board, thus ensuring stable reliability of the electronic component.

Terminal plate 71 can be designed to be in contact both with sealing member 24 and with curled portion 27 of electrolytic capacitor body 21 to substantially eliminate the load applied to lead wires 22 when compliant pins 74 are press-fitted into throughholes 31 of the circuit board.

### Eighth Embodiment

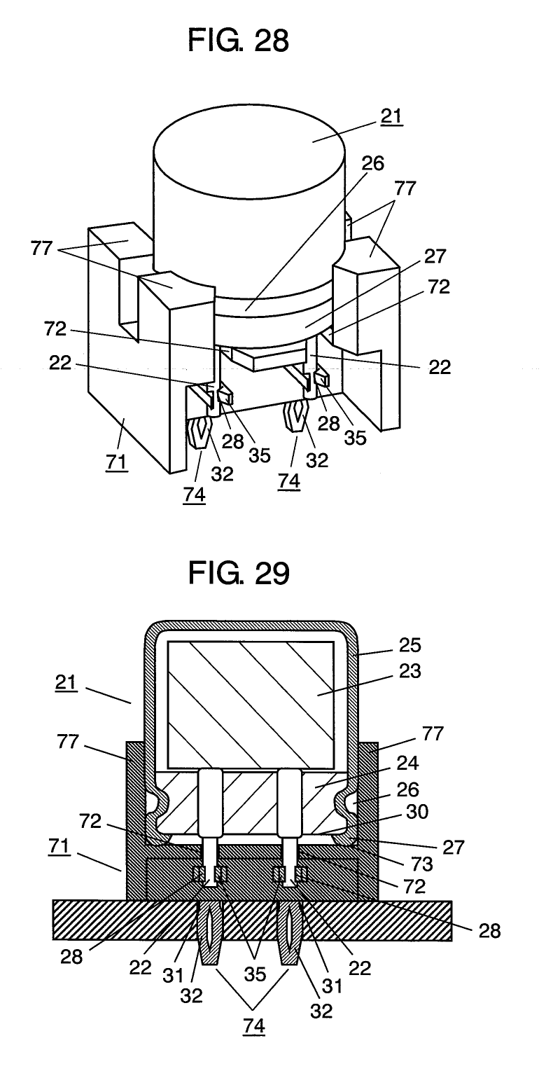

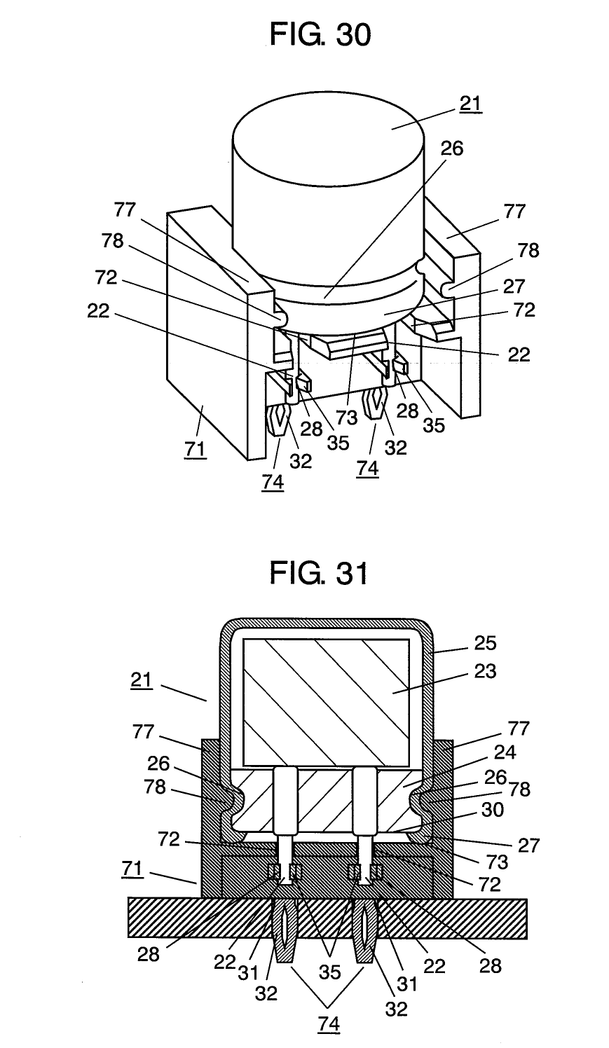

FIG. 28 is a perspective view of an electronic component according to an eighth embodiment of the present invention, and FIG. 29 is a sectional view of the electronic component. FIG. 30 is a perspective view of another electronic component according to the eighth embodiment, and FIG. 31 is a sectional view of the electronic component. Like components are labeled with like reference numerals with respect to the sixth embodiment, and the description of these components is omitted.

As shown in FIGS. 28 and 29, the present embodiment differs from the sixth embodiment in that terminal plate 71, which is in contact with curled portion 27 of electrolytic capacitor body 21 at contact 73, is provided with walls 77. Walls 77 are in contact with parts of the side surfaces of electrolytic capacitor body 21.

In this structure, walls 77 of terminal plate 71 firmly fix electrolytic capacitor body 21, making the electrolytic capacitor more resistant to mechanical vibration and impact.

As shown in FIGS. 30 and 31, walls 77 in contact with parts of the side surfaces of electrolytic capacitor body 21 may include projections 78. Projections 78 are fitted into crimped portion 26 at which the opening of outer metal case 25 is crimped together with sealing member 24. The fitting of projections 78 of walls 77 into crimped portion 26 can fix terminal plate 71 even if there is a slight clearance between terminal plate 71 and lead-wire lead-out surface 30 of electrolytic capacitor body 21.

This structure more effectively reduces the load applied to lead wires 22 when compliant pins 74 are press-fitted into throughholes 31 of the circuit board. This structure also prevents the load from being transmitted to capacitor element 23 of electrolytic capacitor body 21. As a result, capacitor element 23 is free from short circuit and sealing member 24 maintains hermeticity, thus ensuring stable reliability of the electrolytic capacitor.

### Ninth Embodiment

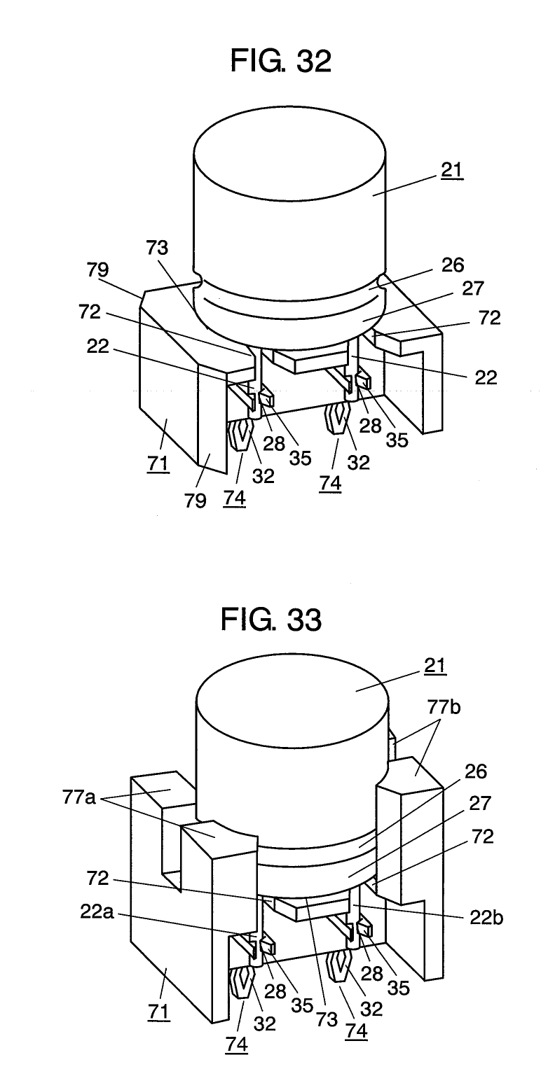

FIG. 32 is a perspective view of an electronic component according to a ninth embodiment of the present invention, and FIG. 33 is a perspective view of another electronic component according to the ninth embodiment. Like components are labeled with like reference numerals with respect to the sixth embodiment, and the description of these components is omitted.

As shown in FIG. 32, the present embodiment differs from the sixth embodiment in that when the pair of lead wires 22 led out from electrolytic capacitor body 21 are different in polarity from each other, terminal plate 71 has chamfered portion 79 at one side thereof as a mark to show the polarity.

This structure facilitates the visual discrimination of the polarities of electrolytic capacitor 21, thereby preventing errors in determining the polarities during the assembly of the electronic device.

As shown in FIG. 33, terminal plate 71 may have a pair of walls 77a and 77b having different heights from each other to show their difference in polarity. Walls 77a and 77b are in contact with parts of the side surfaces of electrolytic capacitor body 21. Alternatively, terminal plate 71 may have asymmetric portions showing their difference in polarity so as to obtain the same effect as providing walls 77a and 77b.

### Tenth Embodiment

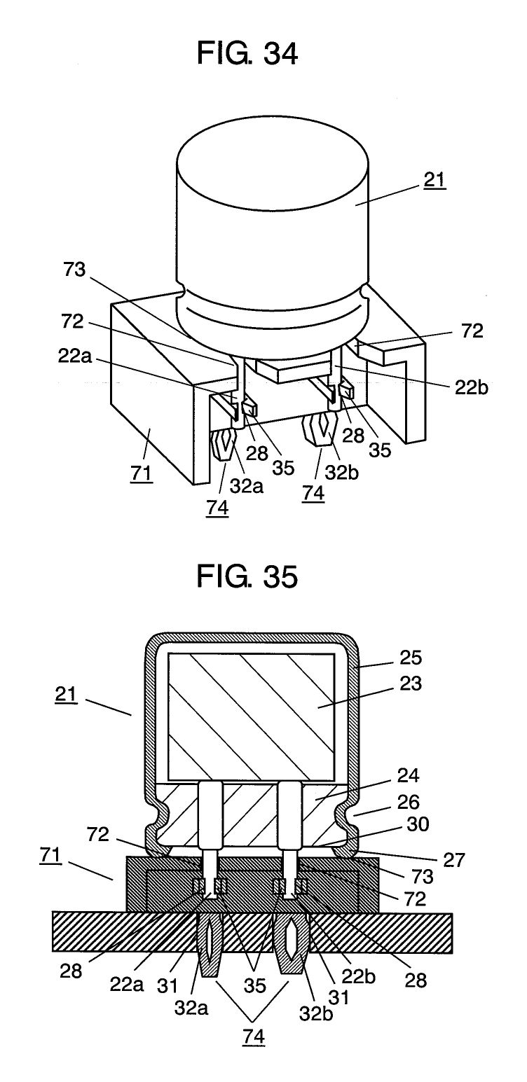

FIG. 34 is a perspective view of an electronic component according to a tenth embodiment of the present invention, and FIG. 35 is a sectional view of the electronic component. Like components are labeled with like reference numerals with respect to the sixth embodiment, and the description of these components is omitted.

As shown in FIGS. 34 and 35, the present embodiment differs from the sixth embodiment in that compliant pins 74 show the polarities. More specifically, compliant pins 74 have anode-side connector 32a and cathode-side connector 32b different from each other in size. When electrolytic capacitor body 21 leads out lead wire 22a and lead wire 22b different in polarity from each other, connectors 32a and 32b to be connected to lead wires 22a and 22b, respectively, are different in size to show the polarities.

This structure facilitates the visual discrimination of the polarities of electrolytic capacitor 21, thereby preventing errors in determining the polarities of the components during the assembly of the electronic device.

Alternatively, to make compliant pins 74 show the polarities, connectors 32a and 32b may be different from each other in shape or in color to obtain the same effect as the structure of FIGS. 34 and 35.

### Eleventh Embodiment

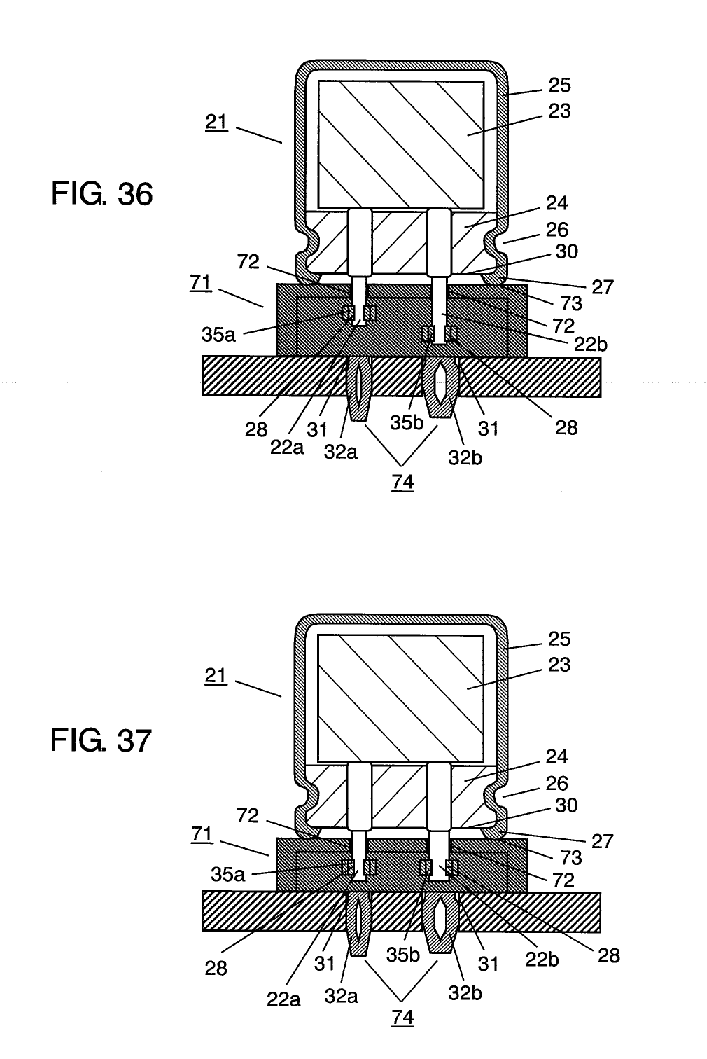

FIG. 36 is a sectional view of an electronic component according to an eleventh embodiment of the present invention, and FIG. 37 is a sectional view of another electronic component according to the eleventh embodiment. Like components are labeled with like reference numerals with respect to the tenth embodiment, and the description of these components is omitted.

As shown in FIG. 36, the present embodiment differs from the tenth embodiment in the following points. Anode lead wire 22a and cathode lead wire 22b lead out from electrolytic capacitor body 21 have different lengths from each other. Compliant pins 74 include anode-side recess 35a and cathode-side recess 35b fitting anode lead wire 22a and cathode lead wire 22b, respectively.

In this structure, a connection cannot be established between compliant pins 74 and the lead wires if they are connected with the wrong polarities. This facilitates visual inspection to detect a wrong polarity connection, thereby preventing errors in determining the polarities during the assembly of the electronic components.

Alternatively, as shown in FIG. 37, anode lead wire 22a and cathode lead wire 22b led out from electrolytic capacitor body 21 may have different thicknesses from each other. Accordingly, compliant pins 74 may include anode-side recess 35a and cathode-side recess 35b fitting anode lead wire 22a and cathode lead wire 22b, respectively, so as to obtain the same effect as in FIG. 36.

### Twelfth Embodiment

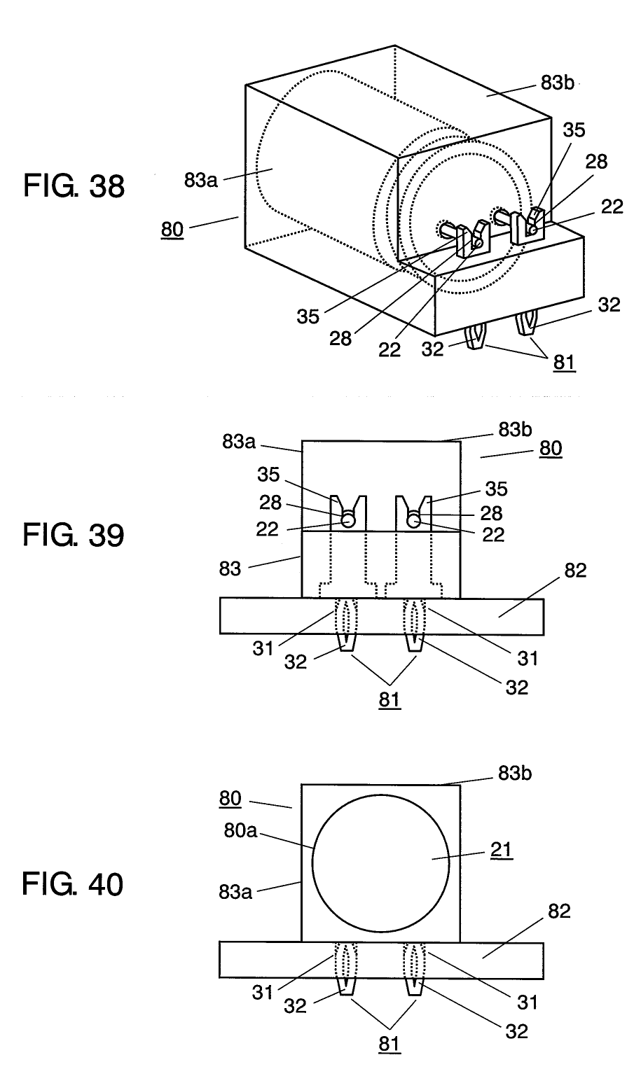

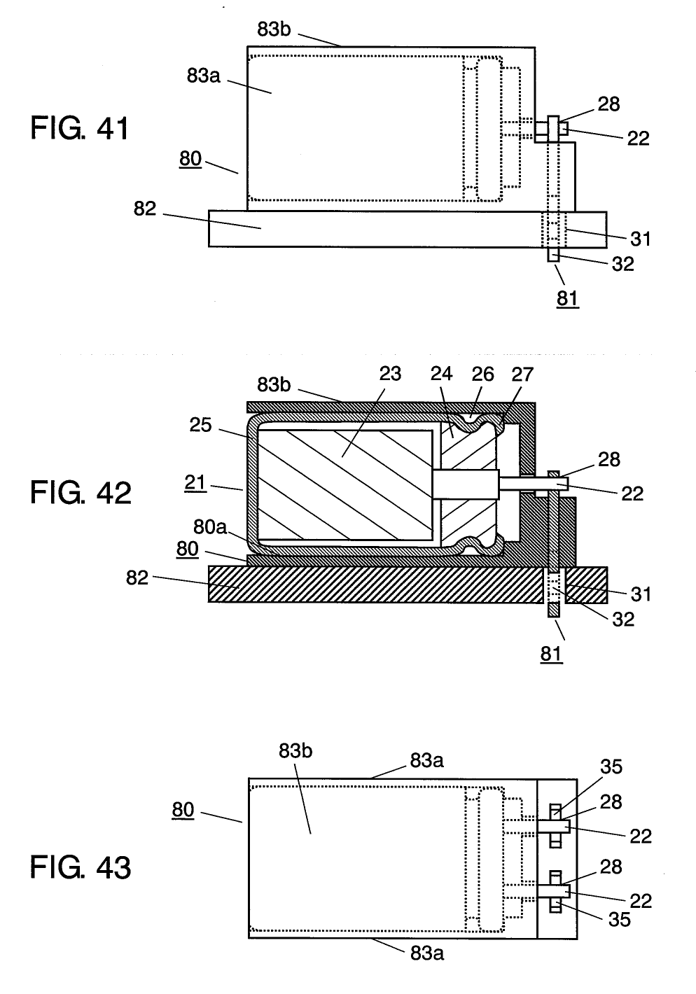

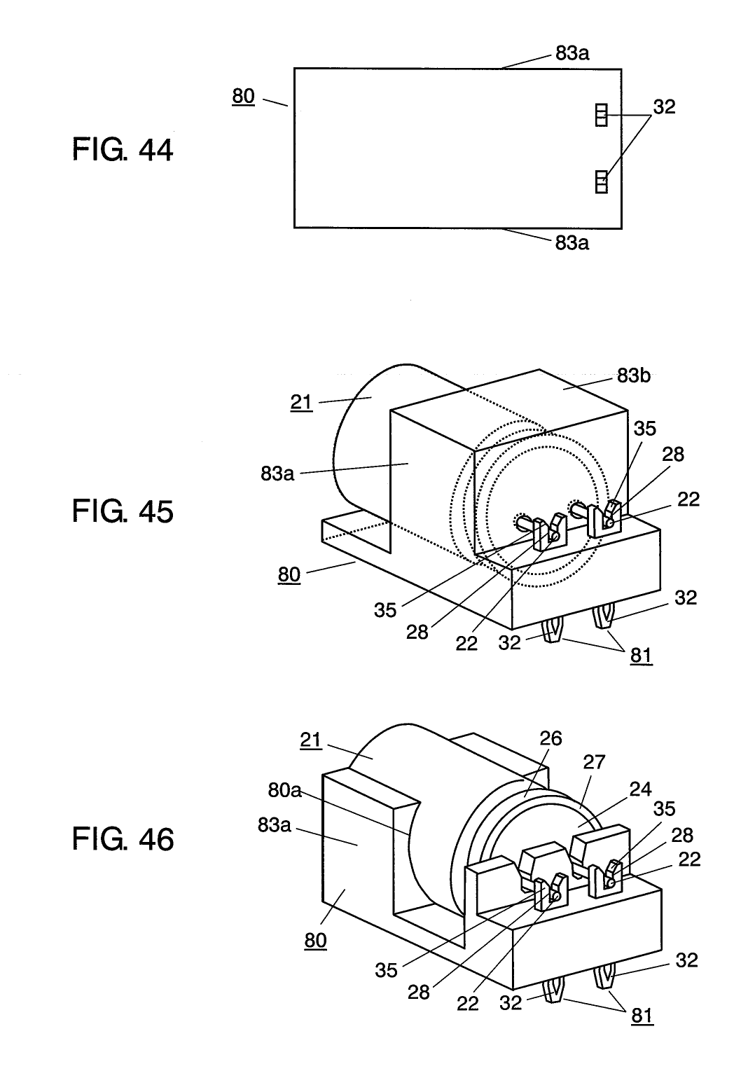

FIG. 38 is a perspective view of an electronic component according to a twelfth embodiment of the present invention, FIG. 39 is a front view of the electronic component, FIG. 40 is a rear view of the electronic component, FIG. 41 is a side view of the electronic component, FIG. 42 is a sectional view of the electronic component, FIG. 43 is a top view of the electronic component, and FIG. 44 is a bottom view of the electronic component. FIGS. 45 and 46 are perspective views of other electronic components according to the twelfth embodiment.

In FIGS. 38 to 44, the electronic component includes electronic component body 21 having a pair of lead wires 22, holder 80 for fixedly holding electronic component body 21, and compliant pins 81 whose parts are fixed to holder 80. In the following description, electrolytic capacitor body 21 is taken as an example of electronic component body 21.

Electrolytic capacitor body 21 includes capacitor element 23 impregnated with an electrolytic solution for driving (unillustrated), sealing member 24 made of an elastic material such as rubber, and outer metal case 25 made of a metallic material such as aluminum. The pair of lead wires 22 led out from capacitor element 23 penetrate sealing member 24, and capacitor element 23 is stored in outer metal case 25. Outer metal case 25 is sealed by crimping and curling its opening at crimped portion 26 and at curled portion 27, respectively, together with sealing member 24.

Holder 80, which is made of an insulating such as a resin, covers the outer peripheral surface of electrolytic capacitor body 21 laid sideways. Holder 80 is in contact with circuit board 82 at holding member 80a and fixed to circuit board 82 or the like.

Compliant pins 81 are partially fixed to holder 80 by, for example, insert molding. Compliant pins 81 are provided at the other end thereof with connections 28 to be connected to lead wires 22 and at one end thereof with connectors 32 to be press-fitted into throughholes 31 of circuit board 82. Connectors 32 can be plural.

Electrolytic capacitor body 21 of the present twelfth embodiment taken as an example of electronic component body 21 is cylindrical and laid sideways. In addition, the pair of lead wires 22 penetrating sealing member 24 are led out in the same direction as each other horizontally to circuit board 82. Alternatively, electronic component body 21 may have a rectangular parallelepiped shape or an elliptic cylinder shape, and lead wires 22 may be led out in the same or opposite directions horizontally to circuit board 82.

In the present twelfth embodiment, the length direction of electronic component body 21 is defined as the direction in which lead wires 22 are led out in the same or opposite directions horizontally to circuit board 82. The width direction of electronic component body 21 is defined as the direction at right angles to the length direction and horizontal to circuit board 82. The height direction of electronic component body 21 is defined as the direction perpendicular to circuit board 82.

In this structure, when electrolytic capacitor body 21 uses sealing member 24 made of an elastic body such as rubber whose strength to hold lead wires 22 is too low to withstand the press-fit load, holder 80 absorbs the load applied when compliant pins 81 are press-fitted into throughholes 31 of circuit board 82. Consequently, the load is prevented from being transmitted to capacitor element 23 via lead wires 22. This substantially eliminates problems such as short-circuiting capacitor element 23 and deteriorating the hermeticity of the portion where the lead wires are led out. In addition, holding member 80a of holder 80 can fix the outer peripheral surface of electrolytic capacitor body 21 to reduce the vibration of electrolytic capacitor body 21 due to mechanical stress such as vibration or impact. This prevents lead wires 22 from damage such as fracture. As a result, the electrolytic capacitor (electronic component) has stable reliability.

Compliant pins 81 include recesses 35 for engaging lead wires 22 as connections 28. Recesses 35 allow lead wires 22 to be fitted thereinto and to be connected to compliant pins 81 by welding, soldering, pressure welding, or the like.

Recesses 35 of compliant pins 81 accommodate lead wires 22 led out from electrolytic capacitor body 21 to facilitate the connection and hence the workability.

Holder 80 includes planar portions 83a formed on the side surfaces and planar portion 83b formed on the top surface.

In this structure, when the electronic component of the present twelfth embodiment is mounted on circuit board 82 using an automatic mounting machine, planar portions 83a on the side surfaces of holder 80 facilitate the grabbing of the electronic component, thereby stabilizing the transfer. In addition, planar portion 83b on the top surface of holder 80 facilitates the application of a load to the electronic component when compliant pins 81 are press-fitted to circuit board 82.

As shown in FIG. 45, holder 80 may have a shape to cover at least part of the outer peripheral surface of electrolytic capacitor body 21 and to hold electrolytic capacitor body 21 at holding member 80a so as to fix electrolytic capacitor body 21. This reduces the vibration of electrolytic capacitor body 21 due to mechanical stress such as vibration or impact, thereby preventing lead wires from damage such as fracture. As a result, the electrolytic capacitor has stable reliability.

Alternatively, as shown in FIG. 46, holding member 80a of holder 80 may be shaped to hold electrolytic capacitor body 21 therein. This allows electrolytic capacitor body 21 to be fixedly fitted into holder 80 from above, thereby improving workability.

### Thirteenth Embodiment

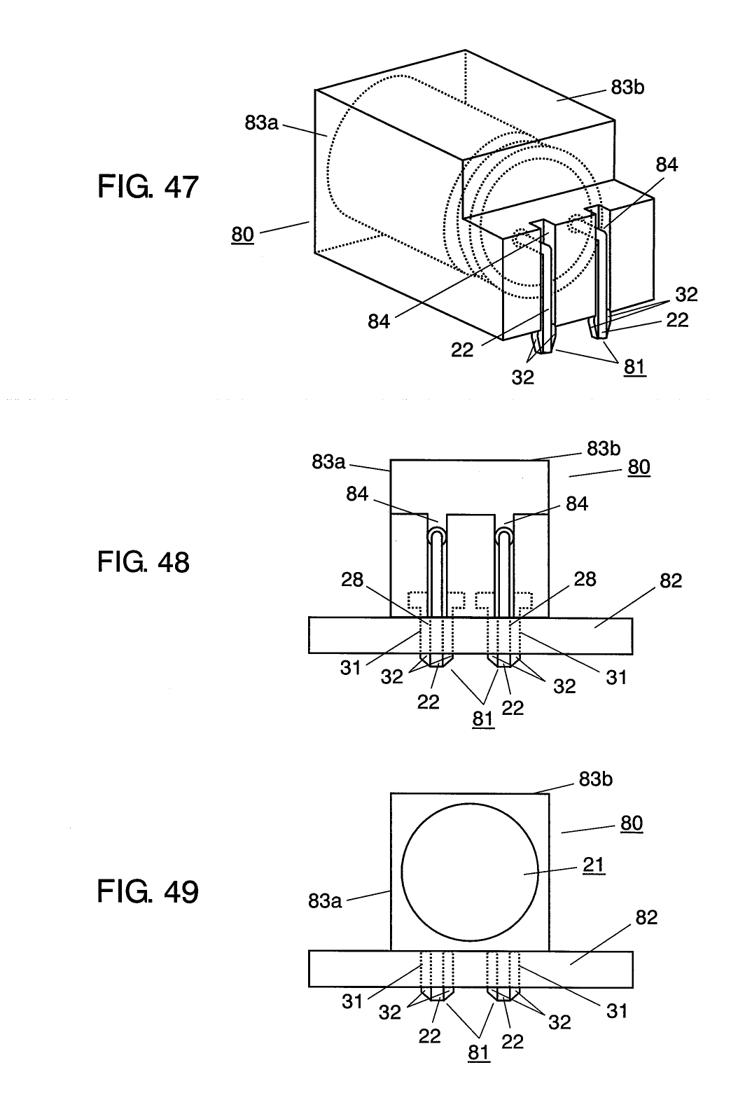

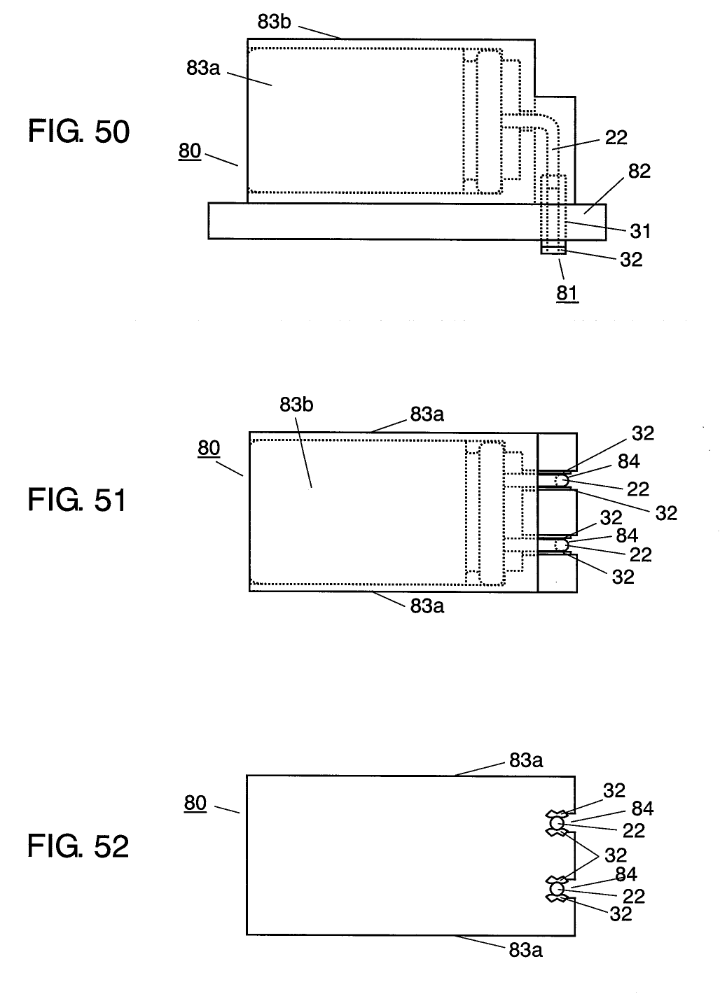

FIG. 47 is a perspective view of an electronic component according to a thirteenth embodiment of the present invention, FIG. 48 is a front view of the electronic component, FIG. 49 is a rear view of the electronic component, FIG. 50 is a side view of the electronic component, FIG. 51 is a top view of the electronic component, and FIG. 52 is a bottom view of the electronic component. Like components are labeled with like reference numerals with respect to the twelfth embodiment, and the description of these components is omitted. The length, width, and height directions of the electronic component body are defined in the same manner as in the twelfth embodiment.

As shown in FIGS. 47 to 52, the present embodiment differs from the twelfth embodiment in the following points. Connectors 32 of compliant pins 81 are in the form of split pins so that the central spaces of split-pin-shaped connectors 32 function as connections 28 to be connected to lead wires 22. Holder 80 is provided in its front with grooves 84 for engaging lead wires 22 along pin-shaped connectors 32.

In this structure, lead wires 22, compliant pins 81, and the plated inner walls of throughholes 31 can be pressure-welded to each other to ensure the electrical connection when compliant pins 81 connected to lead wires 22 are press-fitted into throughholes 31 of circuit board 82. This allows compliant pins 81 and lead wires 22 to be connected to each other without the trouble of welding, soldering, or the like, thus facilitating the workability.

### Fourteenth Embodiment

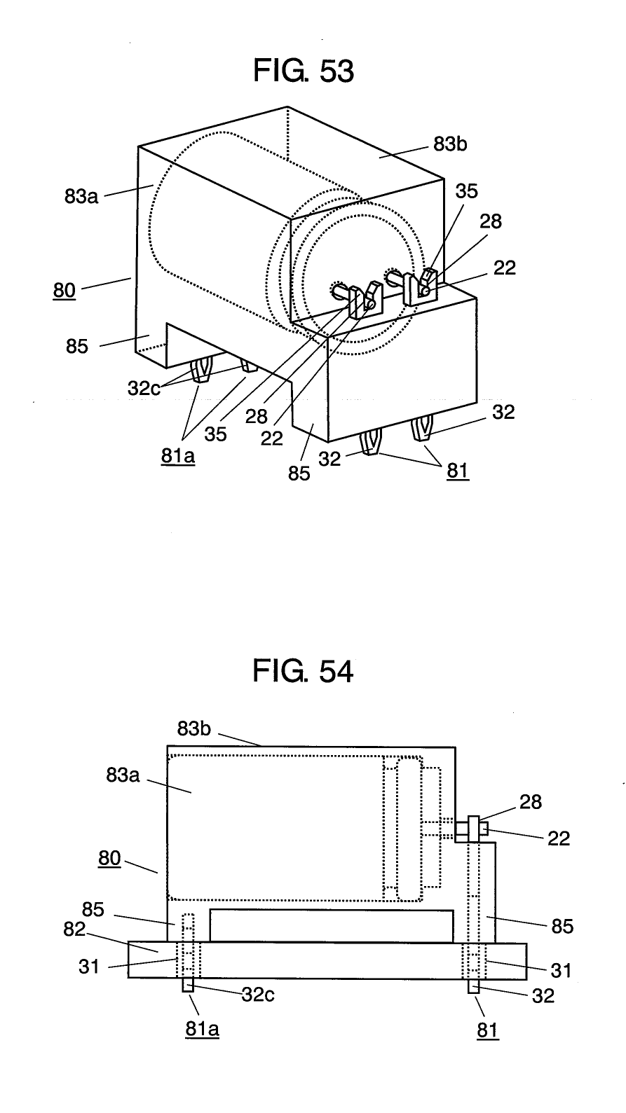

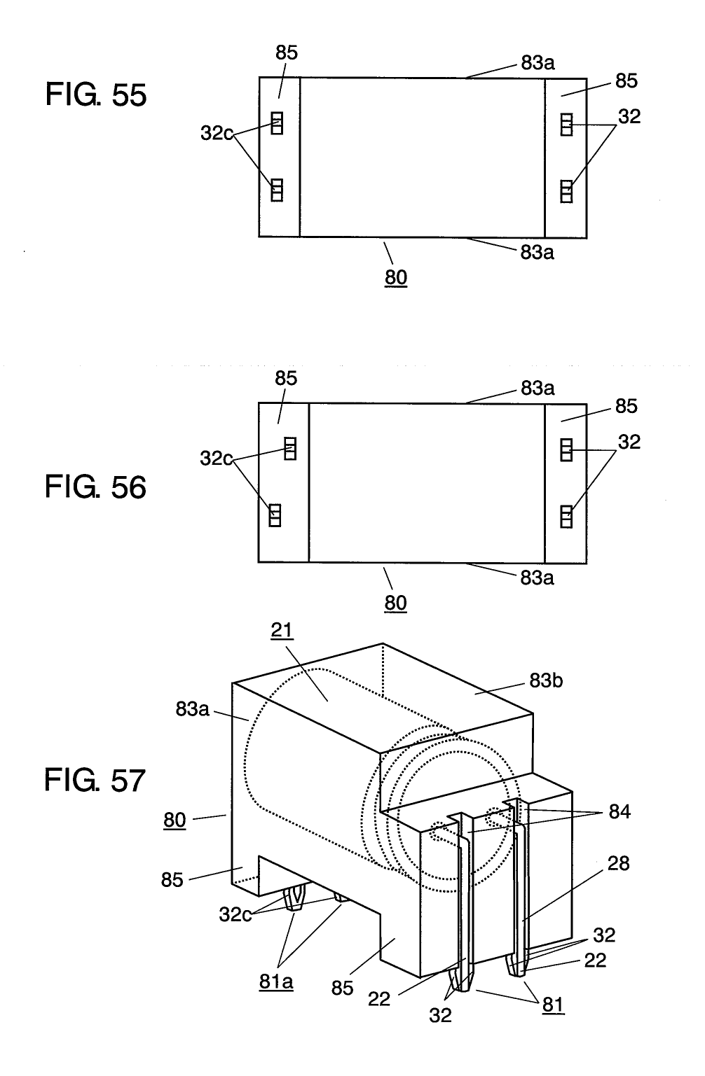

FIG. 53 is a perspective view of an electronic component according to a fourteenth embodiment of the present invention, FIG. 54 is a side view of the electronic component, and FIG. 55 is a bottom view of the electronic component. FIG. 56 is a bottom view of another electronic component according to the fourteenth embodiment, and FIG. 57 is a perspective view of the electronic component. Like components are labeled with like reference numerals with respect to the twelfth embodiment, and the description of these components is omitted. The length, width, and height directions of the electronic component body are defined in the same manner as in the twelfth embodiment.

As shown in FIGS. 53 to 55, the present embodiment differs from the twelfth embodiment in that holder 80 includes stepped portions 85 on a surface thereof facing circuit board 82. Stepped portions 85 are provided to create the space to accommodate other electronic components to be mounted on circuit board 82. Connectors 32 of compliant pins 81 connected to lead wires 22 are formed where stepped portions 85 are in contact with circuit board 82. The present embodiment also differs from the twelfth embodiment in including a pair of dummy auxiliary compliant pins 81a having connectors 32c. Auxiliary compliant pins 81a are partially fixed to holder 80 by, for example, insert molding.

In this structure, the electronic components occupy only a small area of the circuit board in the present fourteenth embodiment and it becomes possible to mount some electronic components in the space beneath holder 80, thus providing efficient layout of components. The electronic component of the present fourteenth embodiment is fixed to the circuit board by not only connectors 32 but also connectors 32c. This increased number of connectors improves the fixation and hence the vibration resistance and impact resistance of the electronic component.

Connectors 32 of compliant pins 81 and connectors 32c of auxiliary compliant pins 81a may be arranged asymmetric as shown in FIG. 56. This prevents connectors 32 or 32c from being inserted into wrong throughholes 31, thereby effectively preventing errors in determining the polarities or other mistakes.

Alternatively, as shown in FIG. 57, connectors 32 of compliant pins 81 may be in the form of split pins shown in the thirteenth embodiment and the central spaces of split-pin-shaped connectors 32 may function as connections 28 to be connected to lead wires 22. In addition, holder 80 may be provided in its front with grooves 84 for engaging lead wires 22 along pin-shaped connectors 32.

Connectors 32c of auxiliary compliant pins 81a have only to be fixedly press-fitted into a board, such as pin-shaped projections integrated with holder 80.

### Fifteenth Embodiment

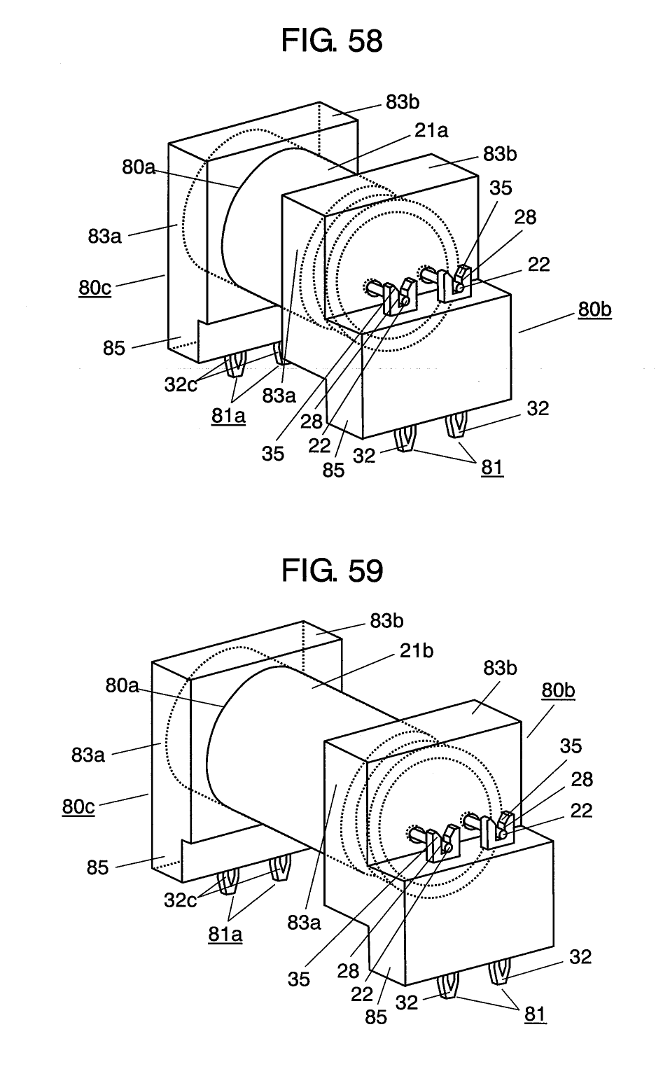

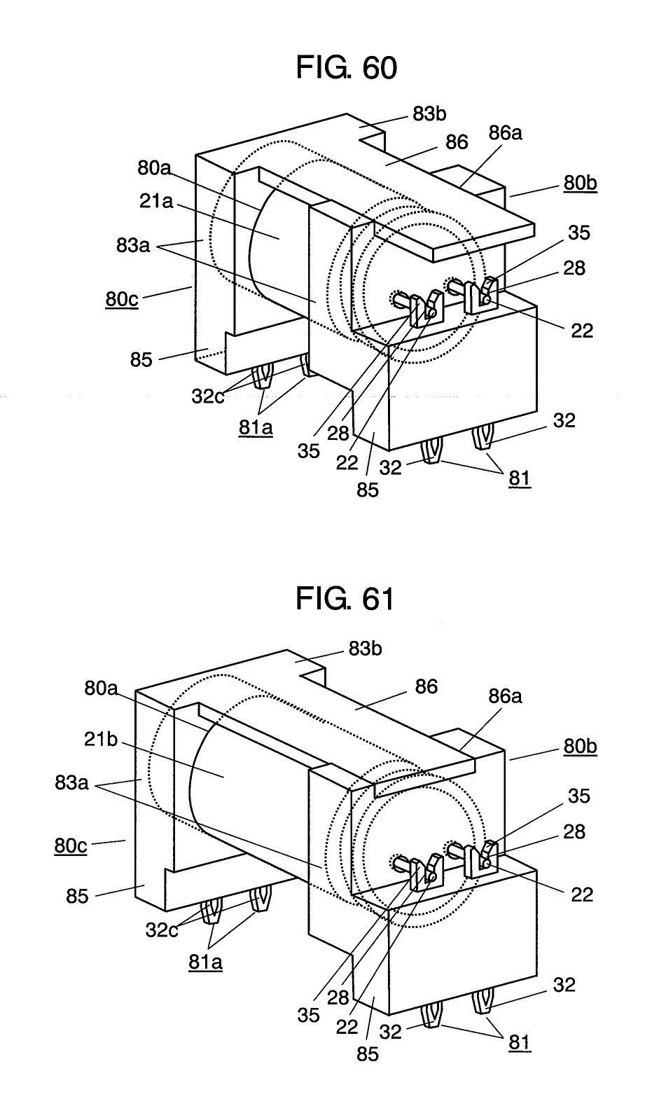

FIG. 58 is a perspective view of an electronic component according to a fifteenth embodiment of the present invention, FIG. 59 is a perspective view of another electronic component according to the fifteenth embodiment, FIG. 60 is a perspective view of another electronic component according to the fifteenth embodiment, and FIG. 61 is a perspective view of another electronic component according to the fifteenth embodiment. Like components are labeled with like reference numerals with respect to the fourteenth embodiment, and the description of these components is omitted. The length, width, and height directions of the electronic component body are defined in the same manner as in the twelfth embodiment.

As shown in FIG. 58, the present embodiment differs from the fourteenth embodiment in that electrolytic capacitor body 21a is held by two holders 80b and 80c separated in the length direction of electrolytic capacitor body 21a. More specifically, holder 80b holds electrolytic capacitor body 21a and partially fixes compliant pins 81. Compliant pins 81 are provided at the other end thereof with connections 28 to be connected to lead wires 22 and provided at one end thereof with connectors 32 to be press-fitted into the throughholes (unillustrated) of a circuit board (unillustrated). Holder 80c, on the other hand, holds the remaining portion of electrolytic capacitor body 21a and partially fixes dummy auxiliary compliant pins 81a. Auxiliary compliant pins 81a are provided at one end thereof with connectors 32c to be press-fitted into the throughholes of the circuit board.

As shown in FIG. 59, when electrolytic capacitor body 21b has a different length from that shown in FIG. 58, the two separated holders 80b and 80c can be used by adjusting the spacing therebetween. In other words, when electrolytic capacitor bodies 21a and 21b shown in FIGS. 58 and 59, respectively, are different from each other in size in the length direction, the same holders 80b and 80c can be used to standardize the components.

As shown in FIG. 60, holder 80c is provided on its top surface with planar projection 86 in the horizontal direction, and holder 80b is provided on its top surface with recess 86a fitting planar projection 86. Planar projection 86 may be slidably fitted into recess 86a so as to improve the mounting workability while combining the two separated holders 80b and 80c with electrolytic capacitor body 21.

The reason for this is that the structure makes it easy to adjust the degree of parallelization of connectors 32 of compliant pins 81 of holder 80b and connectors 32c of dummy auxiliary compliant pins 81a of holder 80c with respect to the circuit board surface (unillustrated).

As shown in FIG. 61, when electrolytic capacitor body 21b has a different length from that shown in FIG. 60, the spacing between holders 80b and 80c can be adjusted by sliding planar projection 86 along recess 86a while maintaining the degree of parallelization of the two separated holders 80b and 80c. Thus, when electrolytic capacitor bodies 21a and 21b have different lengths from each other, the same holders 80b and 80c can be used to standardize the components.

Projection 86 and recess 86a have only to be shaped and positioned to maintain the degree of parallelization of the separated holders 80b and 80c.

### Sixteenth Embodiment

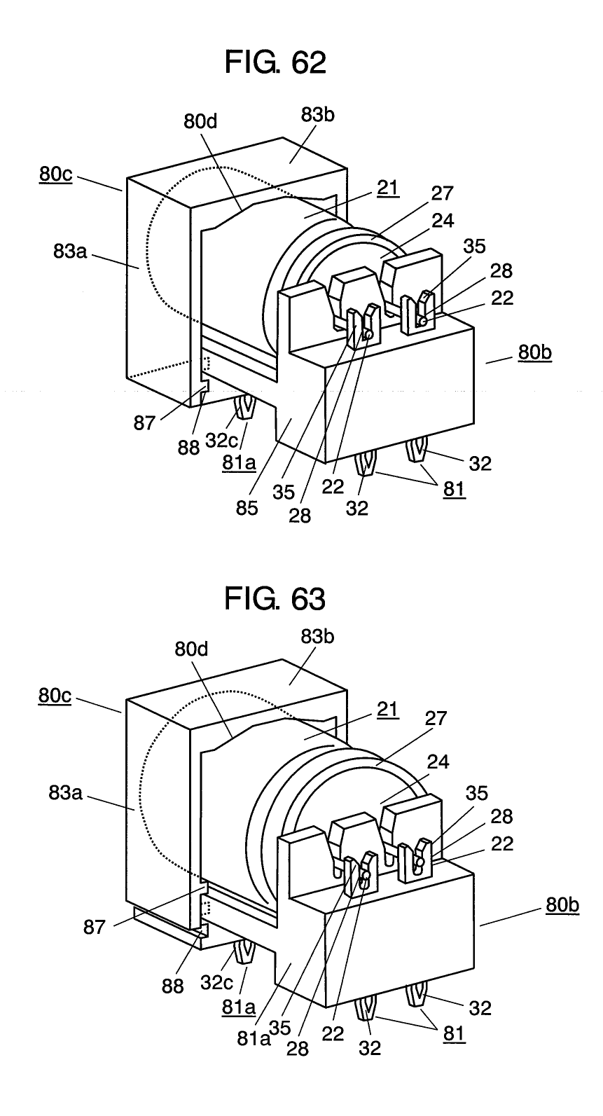

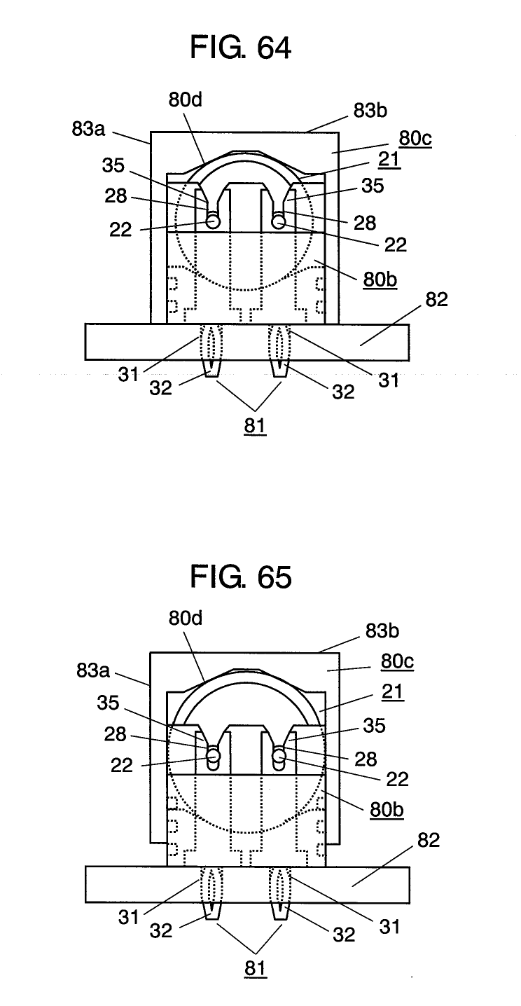

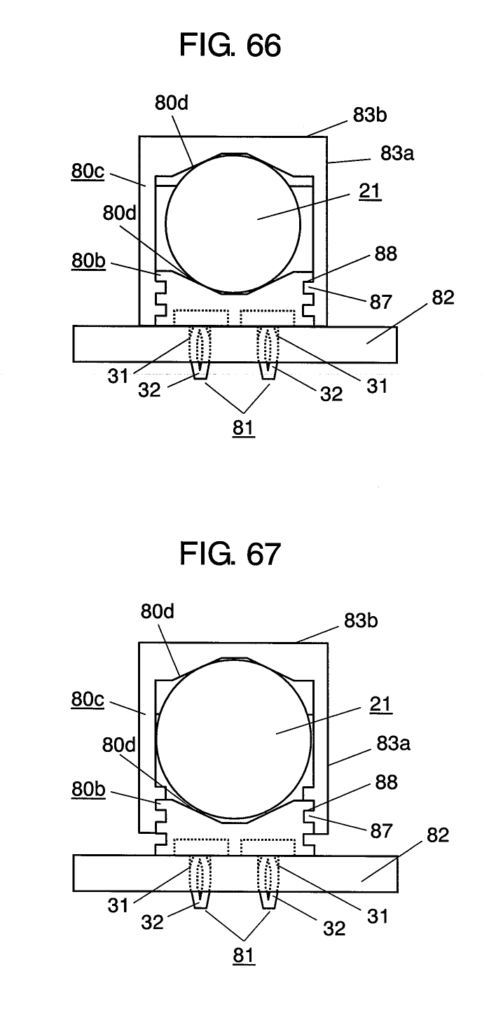

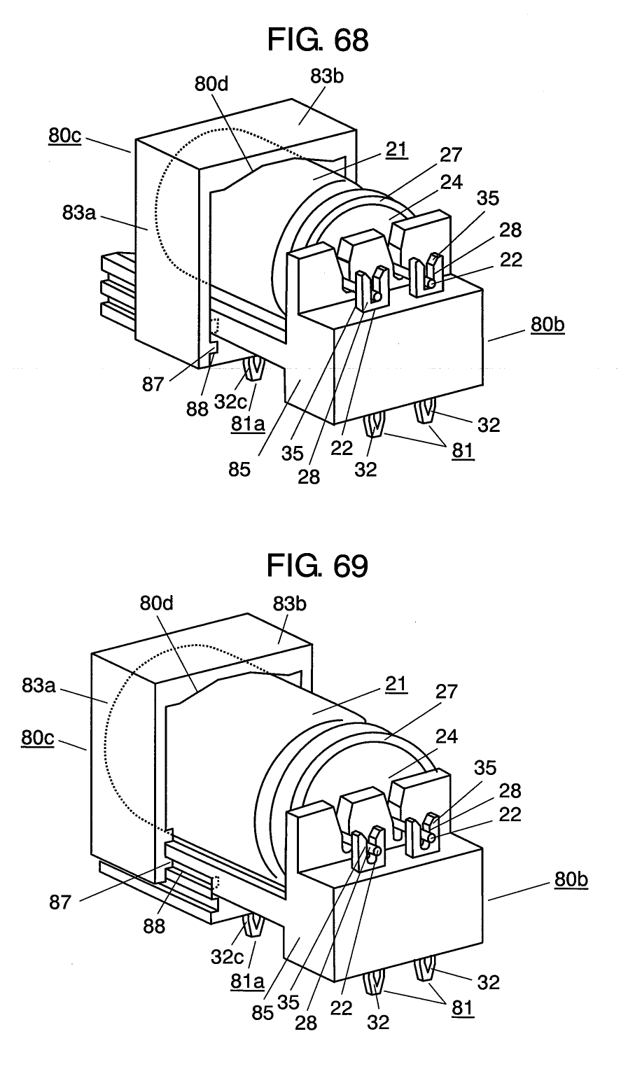

FIG. 62 is a perspective view of an electronic component according to a sixteenth embodiment of the present invention, FIG. 64 is a front view of the electronic component, and FIG. 66 is a rear view of the electronic component. FIG. 63 is a perspective view of another electronic component according to the sixteenth embodiment, FIG. 65 is a front view of the electronic component of FIG. 63, and FIG. 67 is a rear view of the electronic component of FIG. 63. FIG. 68 is a perspective view of another electronic component according to the sixteenth embodiment, and FIG. 69 is a perspective view of another electronic component according to the sixteenth embodiment. Like components are labeled with like reference numerals with respect to the fifteenth embodiment, and the description of these components is omitted. The length, width, and height directions of the electronic component body are defined in the same manner as in the twelfth embodiment.

As shown in FIGS. 62, 64, and 66, the present embodiment differs from the fifteenth embodiment in that electrolytic capacitor body 21 is held by two holders 80b and 80c separated in the height direction of electrolytic capacitor body 21, namely, holder 80b of the upper side and holder 80c of the lower side. Holder 80b is in contact with the bottom of the outer peripheral surface of electrolytic capacitor body 21 at concave holding member 80d and provided at the other end thereof with connections 28 to be connected to lead wires 22. Holder 80b also partially fixes compliant pins 81 which are provided at one end thereof with connectors 32 to be press-fitted into throughholes 31 of circuit board 82. Holder 80b also partially fixes dummy auxiliary compliant pins 81a. Dummy auxiliary compliant pins 81a include connectors 32c to be press-fitted into throughholes 31 of circuit board 82 at a position thereof facing one end of compliant pins 81.

Holder 80c, on the other hand, covers part of the top and sides of the outer peripheral surface of electrolytic capacitor body 21 and is in contact with the part of the top at concave holding member 80d. Holder 80b is provided on both side surfaces thereof with a plurality of projections 87 of the same shape extending horizontally. Holder 80c has a plurality of recesses 88 of the same shape extending horizontally on a portion thereof that is in contact with the side surfaces of holder 80b in such a manner that recesses 88 fit projections 87 on both side surfaces of holder 80b. Recesses 88 slidably receive projections 87 so that holders 80b and 80c can fixedly hold the electrolytic capacitor body.

As shown in FIGS. 63, 65, and 67, when electrolytic capacitor body 21 has a different size in the height direction, the position of holder 80c can be adjusted by vertically shifting the positions to engage projections 87 and recesses 88. Thus, when electrolytic capacitor body 21 has a different size in the height direction, the same holders 80b and 80c can be used to standardize the components.

Alternatively, as shown in FIG. 68, holder 80b of the lower side can be extended in the length direction of electrolytic capacitor body 21 so that holder 80c of the upper side can slide in a wider range in the length direction of electrolytic capacitor body 21. In this case, as shown in FIG. 69, when electrolytic capacitor body 21 has a different size in the height and length directions, the position to engage holder 80c with holder 80b can be changed and adjusted in the height direction, and holder 80c can be slidably adjusted in the length direction. Thus, when electrolytic capacitor body 21 has a different size in the height and length directions, the same holders 80b and 80c can be used to standardize the components.

Alternatively, holders 80b and 80c may be separated in the width direction of electrolytic capacitor body 21. More specifically, holders 80b and 80c may have a slidably combined portion which can be shifted in the width direction of electrolytic capacitor body 21 and fixed by adhesion or other methods. As a result, when electrolytic capacitor body 21 has a different size in the width direction, the same holders 80b and 80c can be used to standardize the components.

### Seventeenth Embodiment

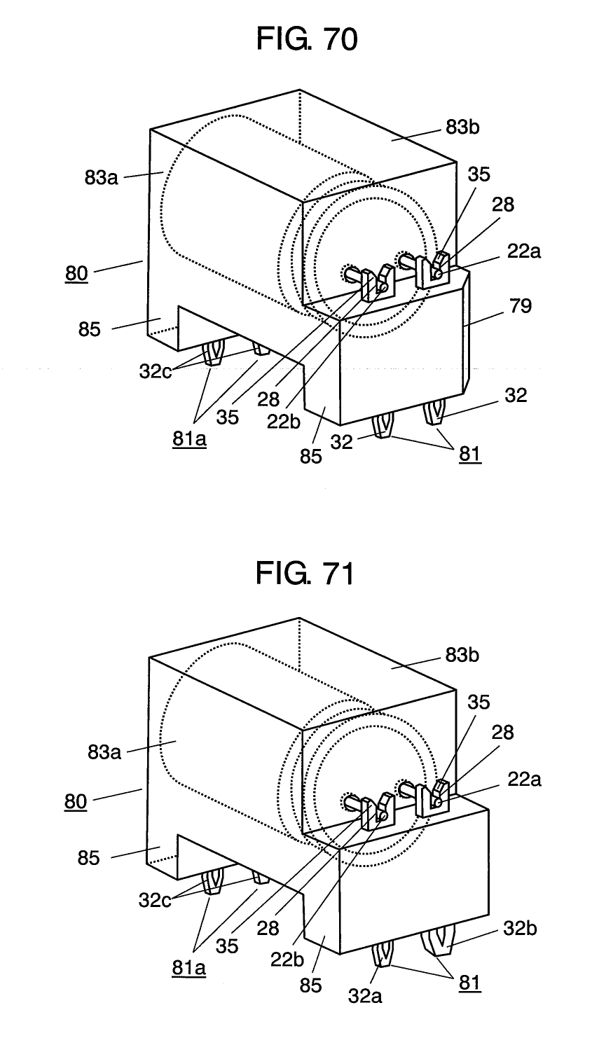

FIG. 70 is a perspective view of an electronic component according to a seventeenth embodiment of the present invention, and FIG. 71 is a perspective view of another electronic component according to the seventeenth embodiment. Like components are labeled with like reference numerals with respect to the fourteenth embodiment, and the description of these components is omitted. The length, width, and height directions of the electronic component body are defined in the same manner as in the twelfth embodiment.

As shown in FIG. 70, the present embodiment differs from the fourteenth embodiment in that when lead wires 22a and 22b led out from electrolytic capacitor body 21 are different in polarity from each other, holder 80 has chamfered portion 79 at one side thereof as a mark to show the polarity.

This structure facilitates the visual discrimination of the polarities of electrolytic capacitor 21, thereby preventing errors in determining the polarities during the assembly of the electronic device.

As shown in FIG. 71, compliant pins 81 connected to lead wires 22a and 22b show the polarities. More specifically, compliant pins 81 have anode-side connector 32a and cathode-side connector 32b different from each other in size. This structure facilitates the visual discrimination of the polarities of electrolytic capacitor 21, thereby preventing errors in determining the polarities of the components during the assembly of the electronic device.

Alternatively, to make compliant pins 81 show the polarities, connectors 32a and 32b may be different from each other in shape or in color to obtain the same effect as the structure of FIG. 71.

### Eighteenth Embodiment

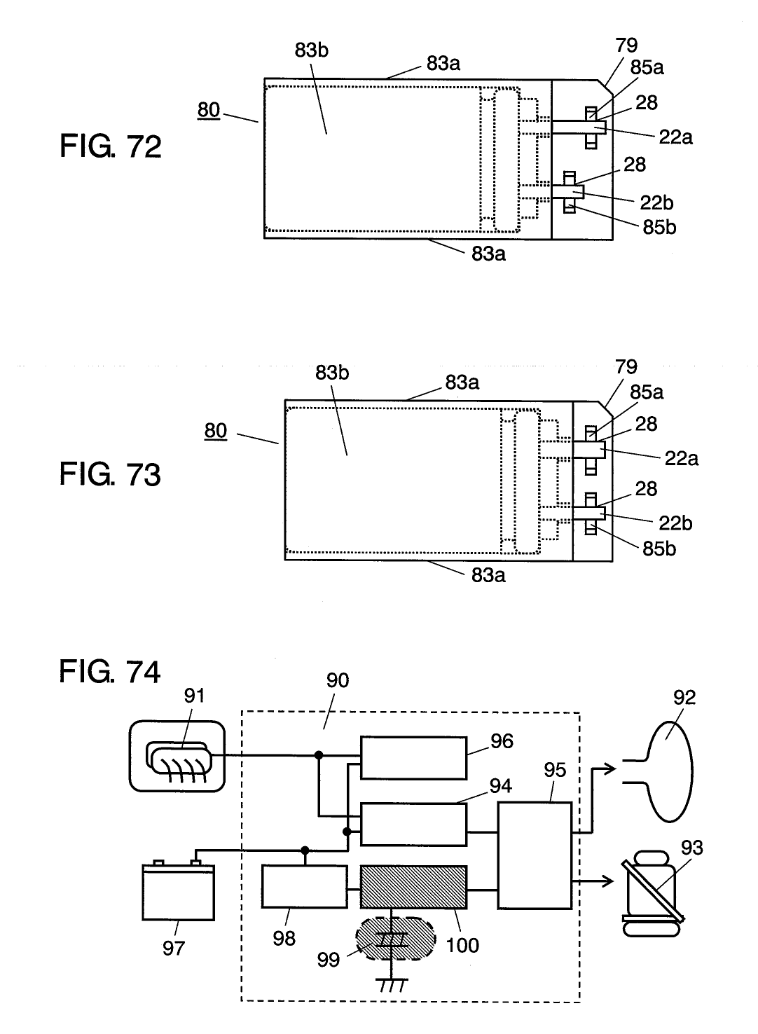

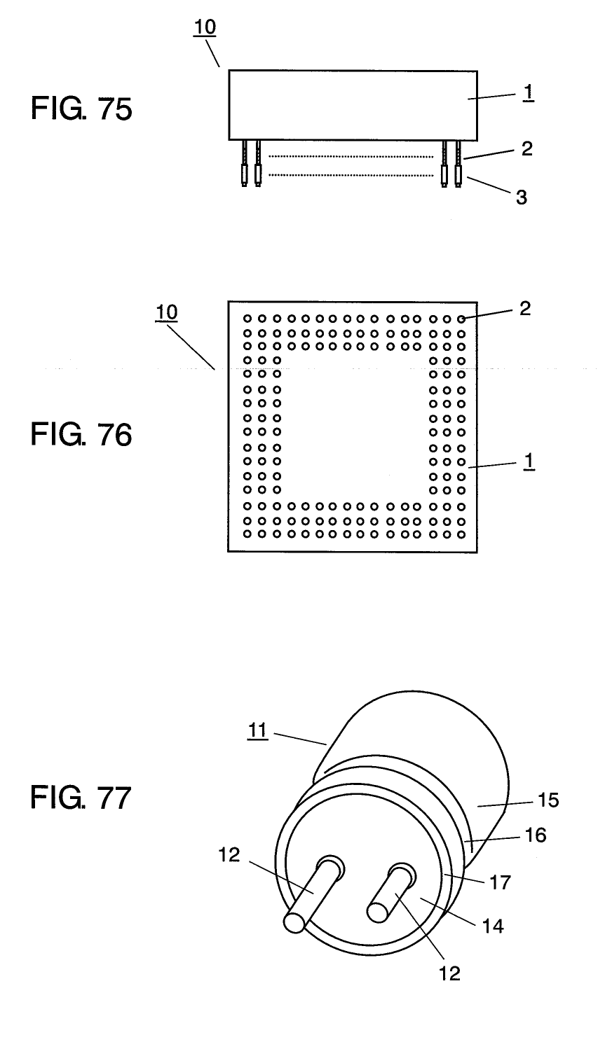

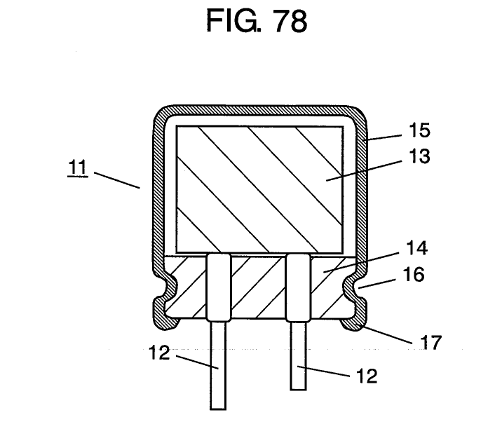

FIG. 72 is a top view of an electronic component according to an eighteenth embodiment of the present invention, and FIG. 73 is a top view of another electronic component according to the eighteenth embodiment. Like components are labeled with like reference numerals with respect to the seventeenth embodiment, and the description of these components is omitted. The length, width, and height directions of the electronic component body are defined in the same manner as in the twelfth embodiment.

As shown in FIG. 72, the present embodiment differs from the seventeenth embodiment in that anode lead wire 22a and cathode lead wire 22b led out from electrolytic capacitor body 21 have different lengths from each other. More specifically, when anode lead wire 22a and cathode lead wire 22b are different in polarity from each other, compliant pins 81 include anode-side recess 85a and cathode-side recess 85b fitting anode lead wire 22a and cathode lead wire 22b, respectively.

In this structure, a connection cannot be established between compliant pins 81 and the lead wires if they are connected with the wrong polarities. This facilitates visual inspection to detect a wrong polarity connection, thereby preventing errors in determining the polarities during the assembly of the electronic components.

In FIG. 73, anode lead wire 22a and cathode lead wire 22b led out from electrolytic capacitor body 21 have different thicknesses from each other. Accordingly, compliant pins 81 include anode-side recess 85a and cathode-side recess 85b fitting anode lead wire 22a and cathode lead wire 22b, respectively. This structure obtains the same effect as the structure of FIG. 72.

### Nineteenth Embodiment

FIG. 74 is a schematic circuit configuration diagram of electronic control device 90 for air-bags and pretensioner seatbelts. Electronic control device 90 is an example of the electronic control device for an automobile which uses one of the electronic components according to the first to eighteenth embodiments of the present invention.

In the circuit configuration shown in FIG. 74, acceleration sensor 91 detects an impact at the collision or overturn of an automobile, and the information is transmitted to electronic control device 90 which controls the operations of air-bags 92, pretensioner seatbelts 93, and the like. More specifically, electronic control device 90 includes control microcomputer 94 which processes the information received from acceleration sensor 91 and sends a command to driving circuit 95 to drive air-bags 92, pretensioner seatbelts 93, and the like. Electronic control device 90 further includes power monitor fail-safe IC 96 which confirms whether battery 97 can supply the power necessary to drive driving circuit 95 through DC/DC converter 98. Electronic control device 90 further includes driving circuit 95 which receives the electric charges stored in power backup capacitor 99 through backup circuit 100 if the wiring in battery 97 is damaged due, for example, to the collision or overturn of the automobile, causing the power supply to be shut down.

Power backup capacitor 99 used in electronic control device 90 requires a large capacitance to control air-bags 92, pretensioner seatbelts 93, and the like. Therefore, it is common to use a comparatively large electrolytic capacitor having a diameter of 16 mm to 20 mm and an overall length of 25 mm to 60 mm.

The electrolytic capacitor (electronic component) of the first to eighteenth embodiments of the present invention can be applied to power backup capacitor 99. As shown in FIGS. 1 to 73, electrolytic capacitor body 21 is held by holders 28 or terminal plate 71, and lead wires 22 or 22a and 22b of electrolytic capacitor body 21 are connected to compliant pins 34, 74, or 81. This effectively reduces the vibration of the electronic component body due to mechanical stress such as vibration or impact. As a result, the lead wires can be prevented from damage such as fracture, and the compliant pins can be mechanically press-fitted into the throughholes of a circuit board.

This structure eliminates the need to control the solder bath or the reflow bath during the soldering process which is conventionally performed for mounting. As a result, production management requirements are reduced, ensuring stable reliability of the electronic device.

### INDUSTRIAL APPLICABILITY

The electronic component of the present invention is applicable to an electronic component capable of being mounted on a board by press-fitting compliant pins, and to an electronic control device using such an electronic component.

1. An electronic component comprising:
an electronic component body having a lead wire led out therefrom; and
a compliant pin having a connector to be press-fitted into a throughhole of a circuit board at one end thereof, the compliant pin also having a connection to be connected to the lead wire.

2. The electronic component of claim 1, further comprising:
one of a base, a terminal plate, and a holder for partially fixing the compliant pin, the one of the base, the terminal plate, and the holder having the connection to be connected to the lead wire of the electronic component body at an other end of the compliant pin.

3. The electronic component of claim 2, wherein
the compliant pin is in contact with a lead-wire lead-out surface of the electronic component body at an end surface on an other side thereof.

4. The electronic component of claim 3, wherein
an area, where the end surface of the compliant pin on the other side thereof is in contact with the lead-wire lead-out surface of the electronic component body, is set to a size large enough to absorb a load applied when the compliant pin is pressed into the throughhole of the circuit board.

5. The electronic component of claim 3, wherein
the electronic component body is an electrolytic capacitor comprising:
a capacitor element including a pair of lead wires and impregnated with an electrolytic solution for driving;
a sealing member made of an elastic body; and
an outer metal case,
the pair of lead wires led out from the capacitor element penetrate the sealing member;
the capacitor element is stored in the outer metal case; and
the outer metal case is sealed by crimping an opening thereof at a crimped portion and curling it at a curled portion, together with the sealing member.

6. The electronic component of claim 3, wherein
the connection include a recess for engaging the lead wire.

7. The electronic component of claim 3, wherein
the lead-wire lead-out surface of the electronic component body includes a rib for insulating the compliant pins.

8. The electronic component of claim 3, wherein
the lead-wire lead-out surface of the electronic component body includes a depression for engaging an end surface of the compliant pin.

9. The electronic component of claim 3, wherein
the compliant pin shows a polarity of the lead wire of the electronic component body.

10. The electronic component of claim 9, wherein
the lead wire of the electronic component body has a structure to show a polarity; and
the connection of the compliant pin includes a recess for engaging the lead wire, the recess having a structure to fit the shape of the lead wire.

11. The electronic component of claim 2, further comprising:
an insulating terminal plate in contact with part of the lead-wire lead-out surface of the electronic component body, wherein
the compliant pin is partially fixed to the terminal plate and provided with the connection to be connected to the lead wire at the other end thereof.

12. The electronic component of claim 11, wherein
an area, where the terminal plate is in contact with the lead-wire lead-out surface of the electronic component body, is set to a size large enough to absorb a load applied when the compliant pin is pressed into the throughhole of the circuit board.

13. The electronic component of claim 11, wherein
the terminal plate includes a wall in contact with part of a side surface of the electronic component body.

14. The electronic component of claim 11, wherein
the terminal plate shows a polarity of the lead wire led out from the electronic component body.

15. The electronic component of claim 11, wherein
the connection of the compliant pin includes a recess for engaging the lead wires.

16. The electronic component of claim 11, wherein
the compliant pin shows a polarity of the lead wire led out from the electronic component body and connected to the compliant pin.

17. The electronic component of claim 15, wherein
the lead wire of the electronic component body has a structure to show a polarity; and
the connection of the compliant pin includes a recess for engaging the lead wire, the recesses having a structure to fit the shape of the lead wire.

18. The electronic component of claim 11, wherein
the electronic component body is an electrolytic capacitor comprising:
a capacitor element including a pair of lead wires and impregnated with an electrolytic solution for driving;
a sealing member made of an elastic body; and
an outer metal case,
the pair of lead wires led out from the capacitor element penetrate the sealing member;
the capacitor element is stored in the outer metal case;
the outer metal case is sealed by crimping an opening thereof at a crimped portion and curling it at a curled portion, together with the sealing member; and
the sealing member made of the elastic body and the curled portion of the outer metal case together form the lead-wire lead-out surface.

19. The electronic component of claim 18, wherein
the terminal plate is entirely in contact with the sealing member made of the elastic body.

20. The electronic component of claim 18, wherein
the terminal plate is in contact with the curled portion of the outer metal case.

21. The electronic component of claim 18, wherein
the terminal plate includes a wall in contact with part of a side surface of the electronic component body, the wall being provided with a projection to be fitted into the crimped portion at which the opening of the outer metal case is crimped together with the sealing member.

22. The electronic component of claim 2, further comprising:
a holder for fixedly holding the electronic component body, wherein
the compliant pin is partially fixed to the holder and provided with the connection to be connected to the lead wire at the other end.

23. The electronic component of claim 22, wherein
the holder has a shape to cover at least part of an outer peripheral surface of the electronic component body.

24. The electronic component of claim 22, wherein
the holder has a shape to hold the electronic component body therein.

25. The electronic component of claim 22, wherein
the holder includes a connector, which is connected to the circuit board, other than the connector of the compliant pin.

26. The electronic component of claim 22, wherein
the holder includes a stepped portion on a surface facing the circuit board, the stepped portion being provided for creating a space to arrange another electronic component to be mounted on the circuit board.

27. The electronic component of claim 22, wherein
the holder includes a planar portion on a surface thereof, the planar portion being mechanically held during a mounting process.

28. The electronic component of claim 22, wherein
the holder shows a polarity of the lead wire led out from the electronic component body.

29. The electronic component of claim 22, wherein
the holder is formed of at least two separate bodies for holding the electronic component body;
at least one of the two separate bodies has the other end of the compliant pin including the connection to be connected to the lead wire, and also partially fixes the compliant pin.

30. The electronic component of claim 29, wherein
at least one of the two separate bodies of the holder includes a connector other than the connector of the compliant pin to be connected to the circuit board.

31. The electronic component of claim 29, wherein the at least two separate bodies are separated in a length direction of the electronic component body, one of the separate bodies being arranged on a side where the lead wire of the electronic component body is led out, and the other of the separate bodies being arranged on an opposite side thereof; and
the separate bodies have a combined portion whose position is adjustable in the length direction of the electronic component body.

32. The electronic component of claim 29, wherein
the at least two separate bodies are separated in a height direction of the electronic component body so as to form an upper body and a lower body; and
the separate bodies have a combined portion whose position is adjustable in the height direction and/or the length direction of the electronic component body.

33. The electronic component of claim 31, wherein
one of the separate bodies separated in the length direction of the electronic component body and arranged on the side where the lead wire of the electronic component body is led out includes one of a projection and a recess, and
the other of the separate bodies arranged on the opposite side thereof includes a part to be engaged with the one of the projection and the recess of the one of the separate bodies slidably in the length direction of the electronic component body.

34. The electronic component of claim 32, wherein
the lower body of the separate bodies separated in the height direction of the electronic component body includes one of a plurality of projections and a plurality of recesses, and
the upper body of the separate bodies includes a part to be engaged with the one of the projections and the recesses of the lower body in such a manner as to be fixed in the height direction of the electronic component body and/or to be slidable in the length direction of the electronic component body.

35. The electronic component of claim 22, wherein
the connection of the compliant pin includes a recess for engaging the lead wire.

36. The electronic component of claim 22, wherein
the connector of the compliant pin is in split pins shape, and
the split-pin-shaped connector engage the lead wire in a central space thereof, the central space functioning as the connection to be connected to the lead wire.

37. The electronic component of claim 22, wherein
the compliant pin shows a polarity of the lead wire led out from the electronic component body and connected to the compliant pin.

38. The electronic component of claim 35, wherein
the lead wire of the electronic component body has a structure to show a polarity; and
the connection of the compliant pin includes a recess for engaging the lead wires, the recess having a shape to fit the shapes of the lead wires.

39. The electronic component of claim 22, wherein
the electronic component body is an electrolytic capacitor comprising:
a capacitor element including a pair of lead wires and impregnated with an electrolytic solution for driving;
a sealing member made of an elastic body; and
a cylindrical outer metal case, wherein
the pair of lead wires led out from the capacitor element penetrate the sealing member;
the capacitor element is stored in the outer metal case; and
the outer metal case is sealed by crimping an opening thereof at a crimped portion and curling it at a curled portion, together with the sealing member.

40. An electronic control device for an automobile, comprising:
an electronic component mounted on a circuit board including the electronic component of claim 1.

41. An electronic control device for an automobile, comprising:
an electronic component mounted on a circuit board including the electronic component of claim 2.

42. An electronic control device for an automobile, comprising: an electronic component mounted on a circuit board including the electronic component of claim 3.

43. An electronic control device for an automobile, comprising:
an electronic component mounted on a circuit board including the electronic component of claim 11.

44. An electronic control device for an automobile, comprising:
an electronic component mounted on a circuit board including the electronic component of claim 22.
